(19) United States
(12) Patent Application Publication
(10) Pub. No.: US 2026/0210181 A1
(43) Pub. Date: Jul. 23, 2026

(54) SWITCHABLE LOCKING DEVICE, AND POSITIONING AND LOCKING SYSTEM EQUIPPED WITH SWITCHABLE LOCKING DEVICE

(71) Applicant: ALEJANDRO BARCHINE, MIAMI BEACH, FL (US)

(72) Inventor: ALEJANDRO BARCHINE, MIAMI BEACH, FL (US)

(21) Appl. No.: 19/577,138

(22) Filed: Mar. 24, 2026

Related U.S. Application Data
(63) Continuation-in-part of application No. 18/821,161, filed on Aug. 30, 2024, now Pat. No. 12,590,491.
Application No. 18/821,161 is a continuation of application No. 16/817,520, filed on Mar. 12, 2020, now Pat. No. 12,091,915.
(60) Provisional application No. 62/816,947, filed on Mar. 12, 2019.

(51) Int. Cl. E06C 1/383; E06C 7/50; F16H 35/00

(52) U.S. Cl. CPC E06C 1/383; E06C 7/50; F16H 2035/006

(57) ABSTRACT

A positioning and locking system for positioning and maintaining an output member includes a transmission assembly configured to transmit rotational motion, a locking device having a locking element movable between an unlocked position and a locked position, and an actuator operatively coupled to the locking element. In operation, the transmission assembly is permitted to rotate in the unlocked position to allow positioning of the output member. When the locking element is moved to the locked position, the locking element engages a portion of the transmission assembly to prevent rotation thereof, thereby maintaining the output member in a fixed position. The system enables controlled positioning and secure mechanical locking without requiring continuous power input.

### RELATED APPLICATIONS

This application is a Continuation-In-Part Patent Application of U.S. Non-Provisional Patent Application No. 18/821,161, filed August 30, 2024, now U.S. Patent No. 12,590,491, issued March 31, 2026, which is a Continuation Application of U.S. Non-Provisional Patent Application No. 16/817,520, filed March 12, 2020, now U.S. Patent No. 12,091,915, issued September 17, 2024, which claims the benefit of U.S. Provisional Patent Application No. 62/816,947, filed on March 12, 2019.

### BACKGROUND

### Field

The present disclosure relates generally to locking devices, and more particularly to a switchable locking device and to a positioning and locking system incorporating the switchable locking device and configured to provide precise angular positioning and secure locking.

### Background Information

Switchable locking devices are used for many mechanical applications. However, existing switchable locking devices are inefficient in operation and typically require a large space when implemented in mechanical applications, which often increases the overall weight of the resulting device. Conventional switchable locking devices are also not adapted or configured for various types of mechanical applications.

Positioning systems used in mechanical, aerospace, and industrial applications commonly rely on continuous motor torque, friction-based braking mechanisms, or worm gear arrangements to maintain a desired angular position. These conventional approaches suffer from significant drawbacks, including continuous energy consumption to maintain position, susceptibility to back-driving under load, limited angular resolution without complex and bulky gear trains, and wear associated with frictional locking elements. Additionally, such systems typically lack redundancy and may concentrate mechanical loads in localized regions, resulting in reduced durability and reliability.

Therefore, it is desirable to provide a switchable locking device which exhibits high operational efficiency, is adapted for various types of mechanical applications, and is configured to reduce the space and overall weight required for various types of mechanical applications. Additionally, there exists a need for a positioning and locking system equipped with the switchable locking device and capable of providing discrete, selectable angular locking positions with high resolution, minimal energy consumption, distributed load handling, and reliable operation even in the absence of electrical power.

### SUMMARY

According to one aspect of the present invention, a switchable locking device is provided including a tubular case defining an internal space and a locking element configured to be received entirely within the internal space and to slide along a central axis of the tubular case. The locking element is movable in a first direction to connect the tubular case to a rotatable transmission member and in a second direction opposite to the first direction to disconnect the tubular case from the rotatable transmission member, with the locking element remaining fully contained within the tubular case during movement in the first and second directions.

According to another feature, the locking element includes external locking teeth and internal locking teeth, wherein the external locking teeth are configured to engage corresponding internal slots of the tubular case to prevent rotation of the locking element relative to the tubular case while permitting axial sliding movement. The internal locking teeth are configured to engage external teeth of the rotatable transmission member when the locking element is moved in the first direction, thereby connecting the tubular case to the rotatable transmission member.

In a further feature, the locking element is configured to slide along the rotatable transmission member through engagement between the internal locking teeth of the locking element and the external teeth of the rotatable transmission member during movement in the first and second directions.

In yet another feature, when the tubular case is connected to the rotatable transmission member via the locking element, rotation of the rotatable transmission member is prevented, thereby enabling secure locking of a transmission assembly associated therewith.

According to one aspect of the present invention, a positioning and locking system is provided for positioning and locking an output member, the system including a transmission assembly configured to transmit rotational motion, a locking device having a locking element movable between unlocked and locked positions, and an actuator configured to move the locking element between the unlocked and locked positions. In the unlocked position, the transmission assembly is permitted to rotate to position the output member, and in the locked position, the locking element engages a portion of the transmission assembly to prevent rotation thereof and maintain the output member in a locked position.

According to another feature, the transmission assembly includes a drive shaft and at least one rotatable transmission member operatively coupled to the drive shaft, the rotatable transmission member comprising a compound gear having multiple toothed portions. The locking element is configured to selectively engage a toothed portion of the rotatable transmission member to prevent rotation of the transmission assembly. The transmission assembly further includes an interior ring member and an exterior ring member, with the rotatable transmission member disposed therebetween to transmit rotational motion between the ring members.

According to a further feature, the locking device includes a tubular case configured to receive the locking element and guide axial movement thereof, and the actuator includes a solenoid actuator having a plunger operatively connected to the locking element. The locking element includes locking teeth configured to engage corresponding teeth of the rotatable transmission member when moved to the locked position.

In one embodiment, the positioning and locking system is provided with only one locking device, one actuator, and one rotatable transmission member.

In another embodiment, the positioning and locking system is provided with two or more locking devices and a corresponding number of actuators and rotatable transmission members.

It will be understood that the foregoing summary is provided to introduce certain concepts of the invention in a simplified form and is not intended to identify all key features or essential elements of the invention, nor to limit the scope of the claimed subject matter. Additional features, aspects, and advantages of the invention will become apparent from the following detailed description and the accompanying drawings. The scope of the invention is defined solely by the appended claims and their equivalents.

### BRIEF DESCRIPTION OF THE DRAWINGS

The accompanying drawings are included to provide a further understanding of the present invention and are incorporated in and constitute a part of this specification. The drawings illustrate various embodiments of the switchable locking device and positioning and locking system of the present invention and, along with associated components and together with the description, serve to explain the principles, structure, and operation of the invention. It will be understood that the drawings are schematic in nature and are not necessarily drawn to scale, and that certain features may be exaggerated or simplified for clarity of illustration. Like reference numerals are used to designate corresponding or similar elements throughout the drawings.

FIG. 1 is a front view of a switchable locking device according to an embodiment of the present disclosure.

FIG. 2 is a right-side exploded view showing the internal lock and external case of the switchable locking device along with an external rotational shaft to which the external case is configured to be connected to and disconnected from via the internal lock.

FIG. 3 is a perspective of the exploded view in FIG. 2.

FIG. 4 is another perspective of the exploded view in FIG. 2.

FIG. 5 is another perspective of the exploded view in FIG. 2.

FIG. 6 is a side perspective view showing the assembly of the internal lock relative to the external case and the external rotational shaft.

FIG. 7 is rear perspective view of the assembly in FIG. 6.

FIG. 8 is a right-side view showing the switchable locking device in which the internal lock switched to the “ON” state, and with the external case being depicted in semi-transparent form to allow observation of the internal lock.

FIG. 9 is a rear perspective view of FIG. 8.

FIG. 10 is a cross-sectional side view taken along a horizontal line cutting through the center of the device shown in FIG. 8.

FIG. 11 is a rear cross-sectional perspective view of FIG. 10.

FIG. 12 is a right-side view showing the switchable locking device in which the internal lock switched to the “OFF” state, and with the external case being depicted in semi-transparent form to allow observation of the internal lock.

FIG. 13 is a rear perspective view of FIG. 12.

FIG. 14 is a cross-sectional side view taken along a horizontal line cutting through the center of the device shown in FIG. 12.

FIG. 15 is a rear cross-sectional perspective view of FIG. 14.

FIG. 16 is a side perspective view illustrating an application of the switchable locking device as a transfer gear box for 2WD to 4WD conversion.

FIG. 17 is a side perspective view of FIG. 16.

FIG. 18 is an upper perspective view of FIG. 16.

FIG. 19 is a cross-sectional side view showing the switchable locking device activated by a hydraulic pressure device and the internal lock in the “ON” state.

FIG. 20 is a rear cross-sectional perspective view of FIG. 19.

FIG. 21 is a cross-sectional side view showing the switchable locking device deactivated by the hydraulic pressure device and the internal lock in the “OFF” state.

FIG. 22 is a rear cross-sectional perspective view of FIG. 21.

FIG. 23 is a diagrammatic view illustrating a conventional lock device in the closed state.

FIG. 24 is a diagrammatic view illustrating a conventional lock device in the open state.

FIG. 25 is a cross-sectional side view illustrating an application of the switchable locking device as a lock device with the internal lock shown in the “ON” (closed) state.

FIG. 26 is a rear cross-sectional perspective view of FIG. 25.

FIG. 27 is a cross-sectional side view similar to FIG. 25, but with the internal lock shown in the “OFF” (open) state.

FIG. 28 is a rear cross-sectional perspective view of FIG. 27.

FIG. 29 is a top perspective view illustrating the various angular positions which can be achieved by the lock device incorporating a switchable locking device according to the present disclosure.

FIG. 30 illustrates various exemplary locations for the locking device according to the present disclosure in a folding multi-position ladder.

FIG. 31 is a perspective view illustrating a switchable locking device according to the present invention applied to articulated arms.

FIG. 32 is a top view of the switchable locking device shown in FIG. 31.

FIG. 33 is a perspective view similar to FIG. 31, with the articulated arms of the switchable locking device in a disconnected state.

FIG. 34 is a top, partially exploded perspective view of the switchable locking device shown in FIG. 32.

FIG. 35 is a left perspective view of the switchable locking device shown in FIG. 34.

FIG. 36 a right perspective view of the switchable locking device shown in FIG. 34.

FIG. 37 is a side view in perspective of the switchable locking device shown in FIG. 34.

FIG. 38 is another exploded view in perspective illustrating a main shaft and switchable locking device removed from one of the articulated arms of the switchable locking device.

FIG. 39 is a right perspective view of the switchable locking device shown in FIG. 38.

FIG. 40 is a top view of a positioning and locking system (hereinafter also referred to herein as “system”) equipped with a switchable locking device (SLD) of the present invention.

FIG. 41 is a side view of the system.

FIG. 42 is partial exploded view in perspective of the system.

FIG. 43 is another perspective exploded view of the system.

FIG. 44 is a partial perspective exploded view of another embodiment of the system according to the present invention.

FIG. 45A is a perspective view of a tubular case for the system according to the embodiments of the present invention, the tubular case constituting a component of the SLD.

FIG. 45B is another perspective view of the tubular case.

FIG. 46 is a perspective view of a locking element for the system according to the embodiments of the present invention, the locking element constituting a component of the SLD.

FIG. 47A is perspective view of a secondary gear for the system in the embodiments of the present invention.

FIG. 47B is another perspective view of the secondary gear.

FIG. 47C is bottom end view of the secondary gear.

FIG. 47D is a top end view of the secondary gear.

FIGS. 48A-48D illustrate various angular locking positions of the secondary gear, according to the present invention.

FIG. 49 is an elevational view of an actuator for the system in the embodiments of the present invention, illustrating a configuration of the actuator in an unlocked state/position of the SLD.

FIG. 50 is an elevational view of an actuator for the system in the embodiments of the present invention, illustrating a configuration of the actuator in a locked state/position of the SLD.

FIG. 51 is a cross-sectional view taken along the line A-A in FIG. 49.

FIG. 52 is a cross-sectional view taken along the line B-B in FIG. 50.

FIG. 53 is an exploded view of the actuator.

FIG. 54A is a perspective view of a bushing for the system in the embodiments of the present invention.

FIG. 54B is an end view of the bushing.

FIG. 55 is a perspective view of one implementation of the system, according to an embodiment of the present invention.

FIG. 56 is a perspective view of another implementation of the system, according to another embodiment of the present invention.

### DETAILED DESCRIPTION

The present disclosure now will be described more fully hereinafter with reference to the accompanying drawings, in which exemplary aspects and embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art.

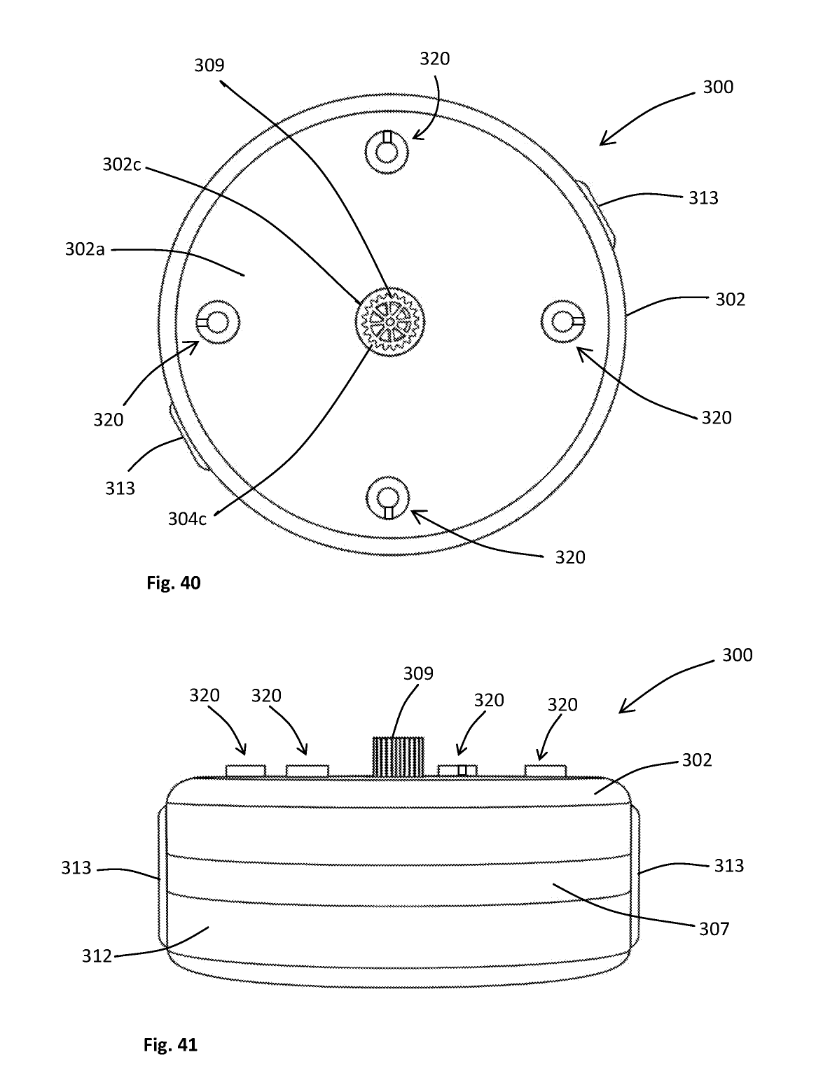

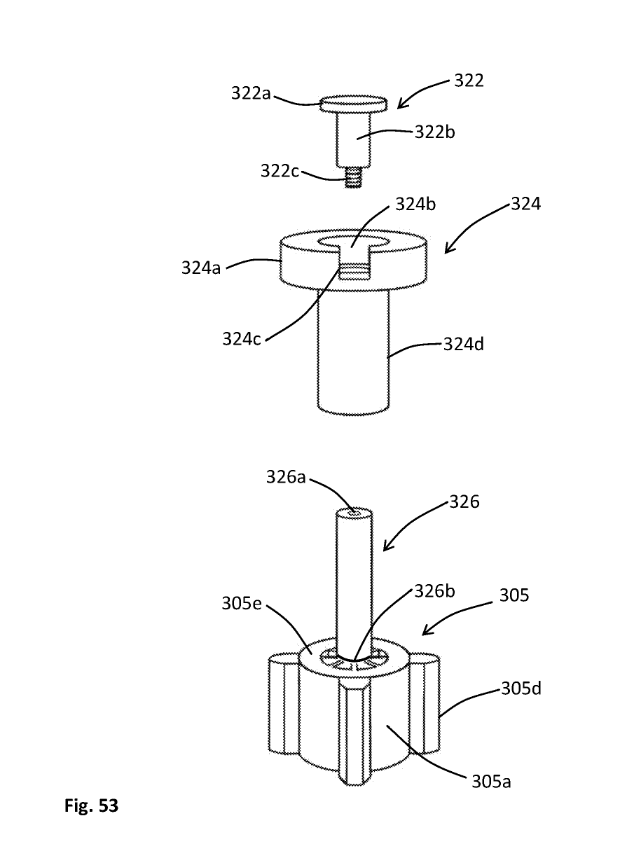

Unless expressly stated otherwise, the use of directional or relational terms such as “top,” “bottom,” “upper,” “lower,” “above,” “below,” “inner,” “outer,” “inside,” “outside,” “front,” “rear,” “left,” “right,” “vertical,” “horizontal,” and words of similar import are used solely for convenience in describing the embodiments of the present invention with reference to the orientations shown in the drawings (e.g., FIGS. 40-56) and are not intended to limit the invention to any particular orientation or configuration. It will be understood that the components of the system may be oriented differently in actual use, and that such terms encompass all equivalent orientations consistent with the structure and operation of the invention. Similarly, terms such as “axial,” “radial,” “circumferential,” “central,” “peripheral,” “inward,” and “outward” are used in a descriptive sense with respect to the illustrated embodiments and are not intended to be limiting.

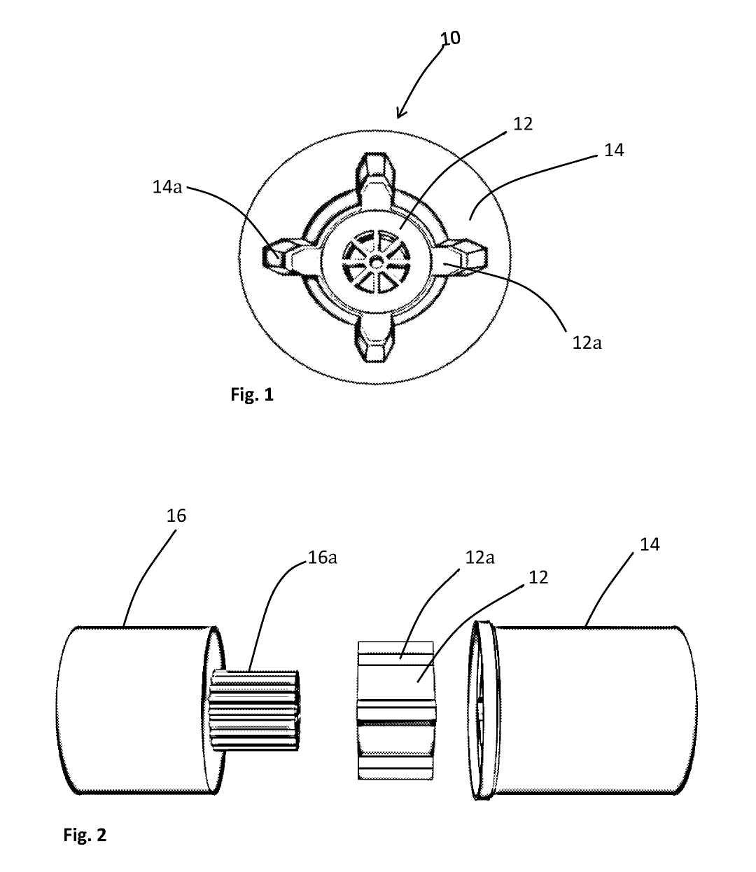

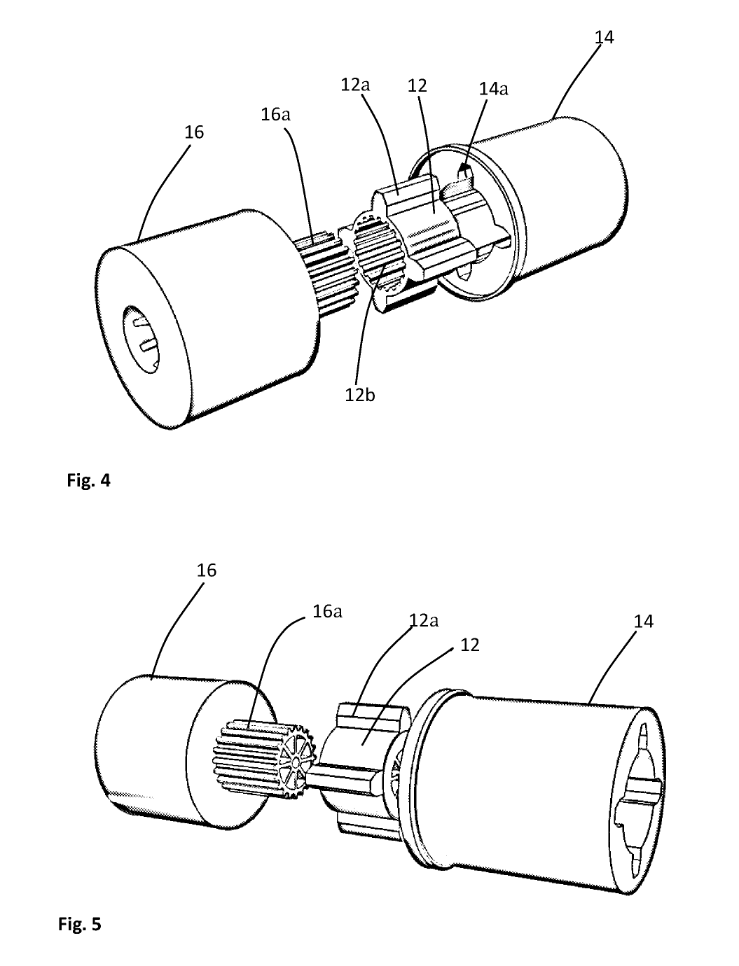

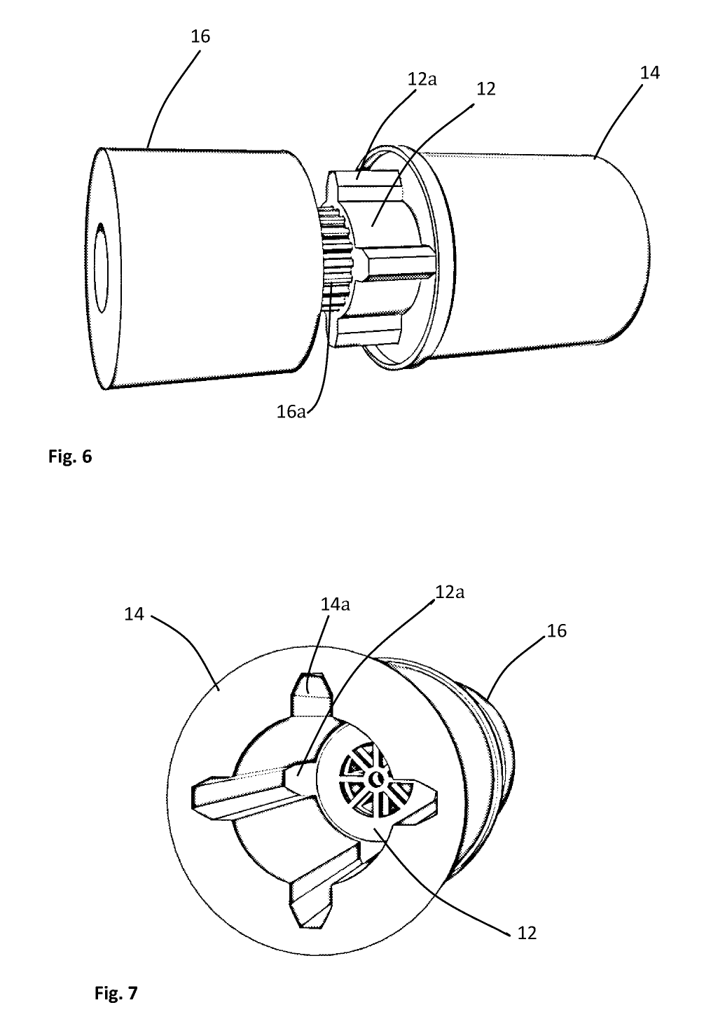

FIGS. 1-7 show various front, right side, exploded, and perspective views illustrating a switchable locking device, generally designated at 10, according to an embodiment of the present disclosure. As shown in FIG. 1, switchable locking device 10 includes a lock connector or switchable lock 12 (hereinafter also referred to herein as “internal lock”) and an external lock or output shaft 14 (hereinafter also referred to herein as “external case”) configured to receive internal lock 12. Internal lock 12 is provided with external locking teeth 12a and external case 14 is provided with slots 14a for meshing engagement with respective external locking teeth 12a of internal lock 12. Internal lock 12 and external case 14 are configured so as to allow the internal lock 12 to slide within and relative to external case 14. Internal lock 12 has a tubular configuration and is provided with internal locking teeth 12a.

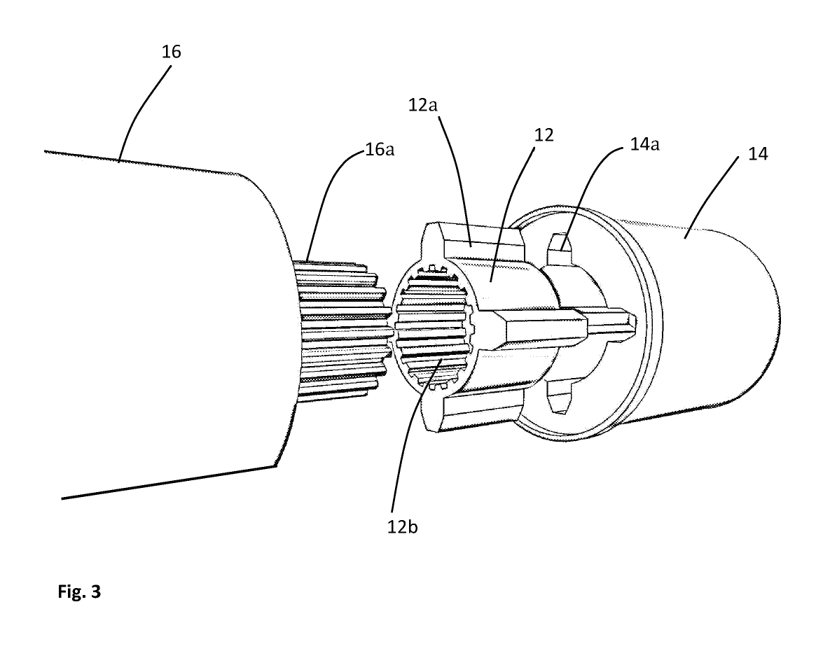

Referring to FIGS. 2-6, external case 14 is configured to be drivingly connected to and disconnected from a main shaft 16 (hereinafter also referred to herein as “external rotational shaft”) via internal lock 12. The driving connection or engagement is accomplished by bringing internal locking teeth 12a of internal lock 12 into meshing engagement with external locking teeth 16a of main shaft 16.

When received within external case 14, internal lock 12 is configured to be selectively switched between an “ON” state and an “OFF” state. In the “ON” state of internal lock 12, external case 14 is connected to main shaft 16 for undergoing rotation therewith (i.e., external case 14 transmits the rotation of main shaft 16). In this “ON” state configuration, external locking teeth 12a of internal lock 12 engage slots 14a of external case 14, and internal locking teeth 12b of internal lock 12 engage external locking teeth 16a of main shaft 16. In the “OFF” state of internal lock 12, external case 14 is disconnected from main shaft 16 and does not undergo rotation therewith (i.e., external case 14 does not transmit the rotation of main 16). In this “OFF” state configuration, external locking teeth 12a of internal lock 12 continue to engage slots 14a of external case 14, however, internal locking teeth 12b of internal lock 12 are disengaged from external locking teeth 16a of main shaft 16. Stated otherwise, in the “OFF” state, external case 14 can rotate freely.

The disengagement of internal locking teeth 12b from external locking teeth 16a described above is accomplished by sliding movement of internal lock 12 within and relative to external case 14. Thus, according to a feature of the present disclosure, internal lock 12 and external case 14 are configured so as to allow internal lock 12 to slide within and relative to external case 14 to selectively place internal lock 12 between the “ON” and “OFF” states.

More specifically, internal lock 12 can be readily switched to the “ON” state by sliding internal lock 12 relative to external case 14 to a first position within external case 14 in which internal locking teeth 12b of internal lock 12 are brought into meshing engagement with external locking teeth 16a of external rotational shaft 16 to transmit rotational movement of external rotational shaft 16 to external case 14 via internal lock 12. Internal lock 12 can be readily switched from the “ON” state to the “OFF” state by sliding internal lock 12 relative to external case 14 to a second position within external case 14 until internal locking teeth 12b of internal lock 12 disengage from external locking teeth 16a of external rotational shaft so that rotational movement of external rotational shaft 16 is not transmitted to external case 14 via internal lock 12.

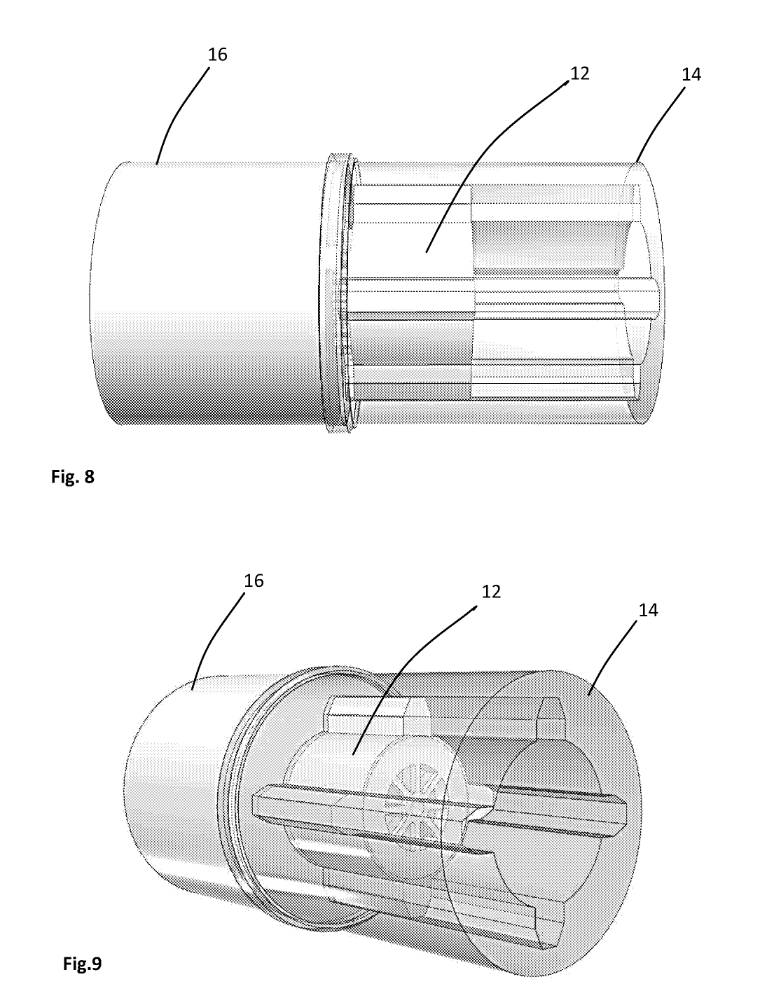

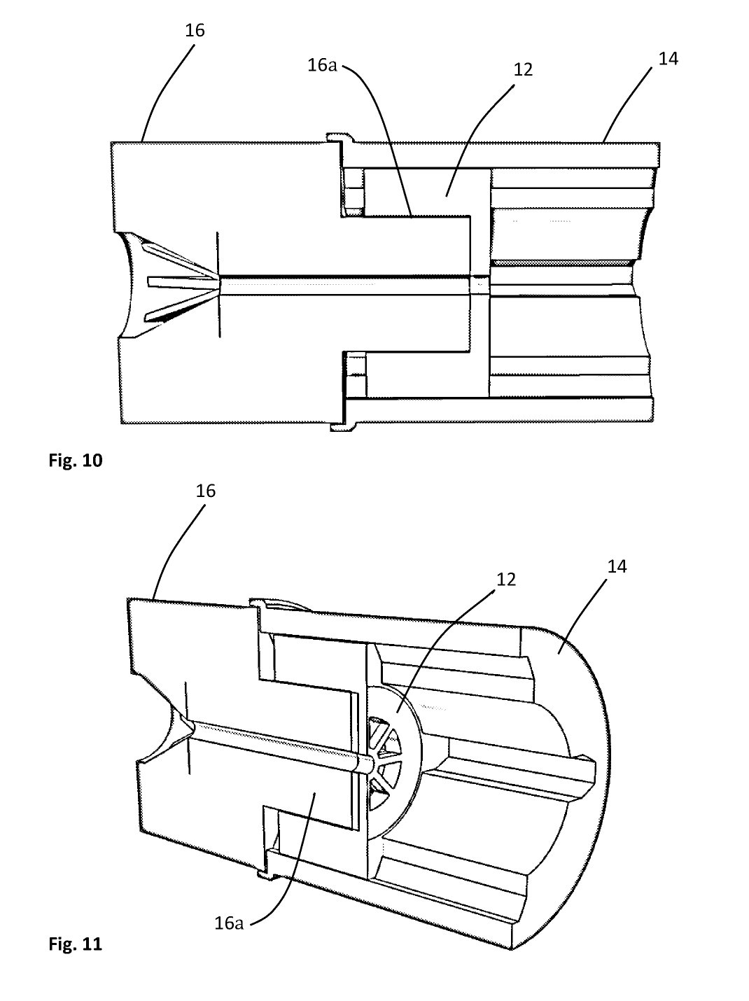

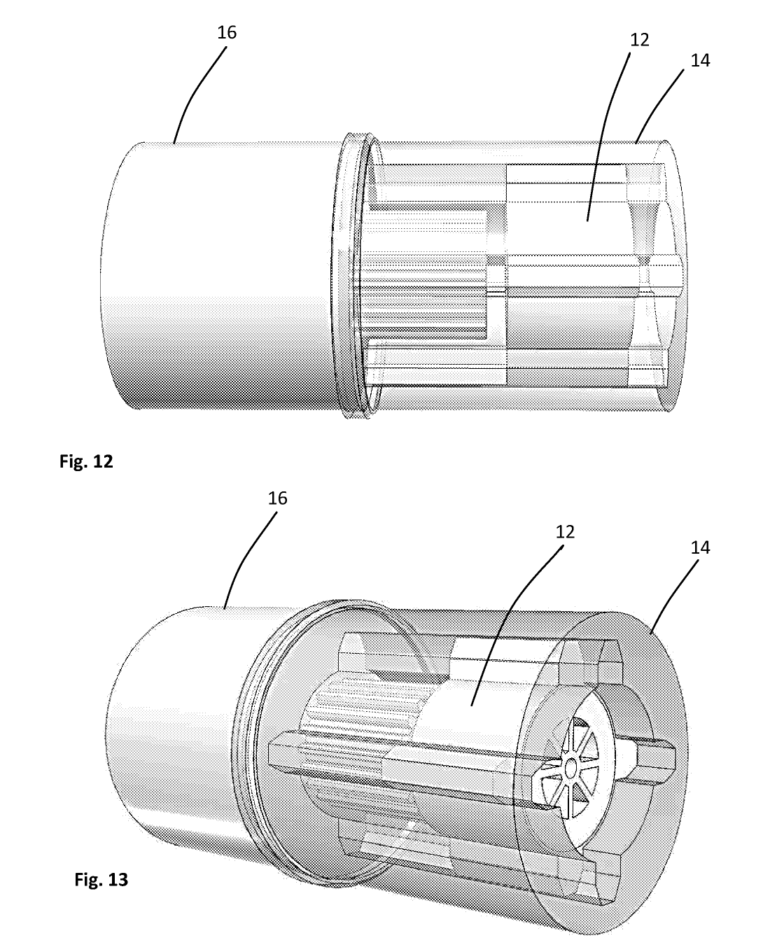

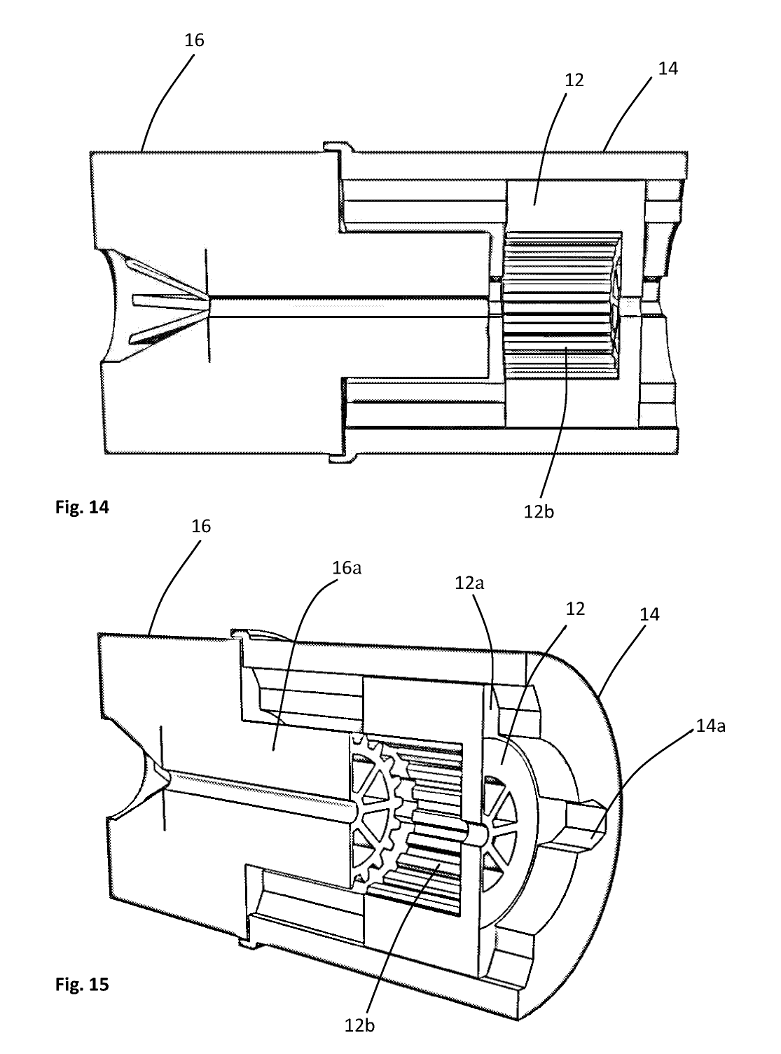

FIGS. 8-11 show various right side, rear, perspective and cross-sectional views of switchable locking device 10 in which internal lock 12 is in the “ON” state (i.e., internal lock 12 is connected to external rotational shaft 16). FIGS. 12-15 show various right side, rear, perspective and cross-sectional views of switchable locking device 10 in which internal lock 12 is in the “OFF” state (i.e., internal lock 12 is disconnected from external rotational shaft 16), thereby enabling external case 14 to rotate freely. In FIGS. 8, 9, 12, and 13, external case 14 is depicted in semi-transparent form to allow observation of internal lock 12. It will be appreciated that switchable locking device 10 is readably switchable “ON” and “OFF” as described above to connect one lock device (i.e., external case 14) to another (i.e., external rotational shaft 16). The configuration (e.g., shape) of switchable locking device 10, including internal lock 12 positionable inside of external case 14 and adapted for sliding movement therein to achieve the “ON” and “OFF” states, effectively reduces the space required for this type of mechanical application, thus reducing the overall weight of the resulting mechanical system in which switchable locking device 10 is applied. Furthermore, since the gear connection between internal lock 12 and external rotational shaft 16 is internal (i.e., inside of external case 14), the resulting mechanical system is able to operate with high efficiency, particularly because it results in a coupling configured to operate as one single, integral piece.

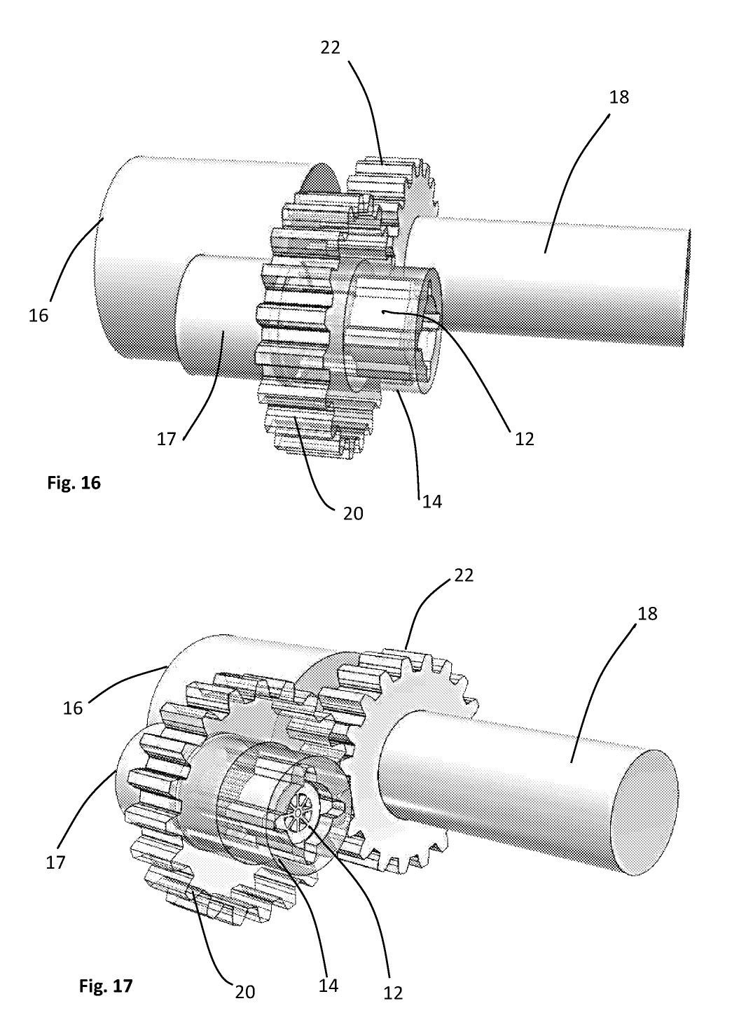

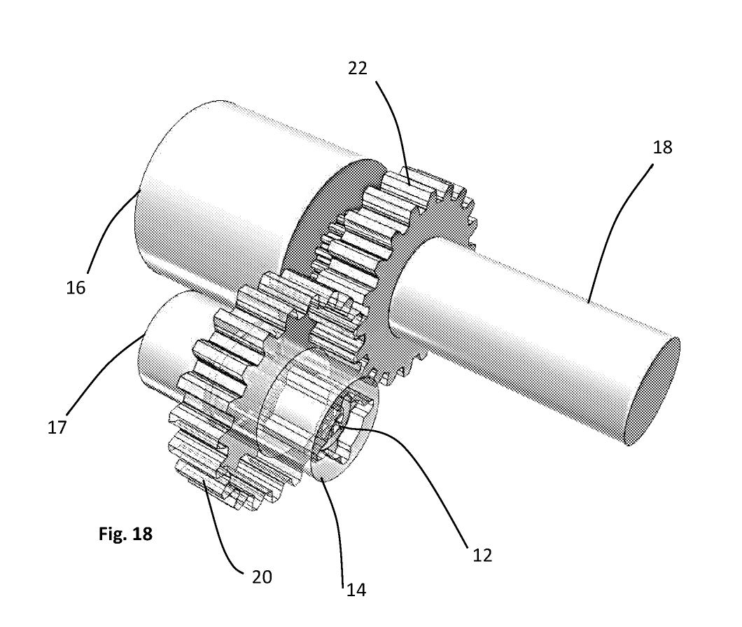

FIGS. 16-18 are perspective views illustrating an application of the switchable locking device in an engine transfer gear box or transfer case for 2WD to 4WD conversion. In these figures, external case 14 is depicted in semi-transparent form to allow observation of internal lock 12.

The arrangement of the transfer case in FIGS. 16-18 illustrates the interconnection and relative positions between switchable locking device 10 (internal lock 12 and external case 14), external rotation shaft 16 (main shaft), first output shaft (4WD) 17, second output shaft (2WD) 18 and corresponding gears 20 and 22. In this configuration, locking device 10 is connected to an engine itself represented by external rotation shaft 16 (main shaft) as described above with reference to FIGS. 2-7. Alternatively, locking device 10 can be connected to a rotor or gear that brings the power of an engine. The function of locking device 10 is to transmit the movement of rotation of an engine when locking device 10 is in the “ON” state (FIGS. 8-11) and to discontinue its rotation when locking device 10 is in the “OFF” state.

More specifically, the function of the arrangement shown in FIGS. 16-18 is as a shift shaft. Internal lock 12 slides into external case 14 to achieve the “ON” state (FIGS. 8-11) in which external case 14 is connected to first output shaft (4WD) 17 to transmit rotation for 2WD/4WD conversion. When internal lock 12 is to be placed in the “OFF” state, internal lock 12 is slid out from first output shaft (4WD) 17 and external case 14 is disconnected from first output shaft (4WD) 17 so that external case 14 can rotate freely (FIGS. 12-15).

By the foregoing arrangement shown in FIGS. 16-18, locking device 10 functions as a switchable interior gear that is switchable “ON” and “OFF” to connect one gear (i.e., external case 14) to another (i.e., first output shaft (4WD) 17) in the “ON” state and disconnect these two gears from each other in the “OFF” state. The design and shape of this configuration, including the internal gear connection and reduction in space as described above, makes this arrangement more effective as compared to conventional transfer gearbox arrangements. Since the connection of the gear is internal, the overall efficiency of the mechanical system is increased because the resulting coupling operates integrally as one piece as internal lock 12 is contained outside by external case 14 and inside by first output shaft (4WD) 17.

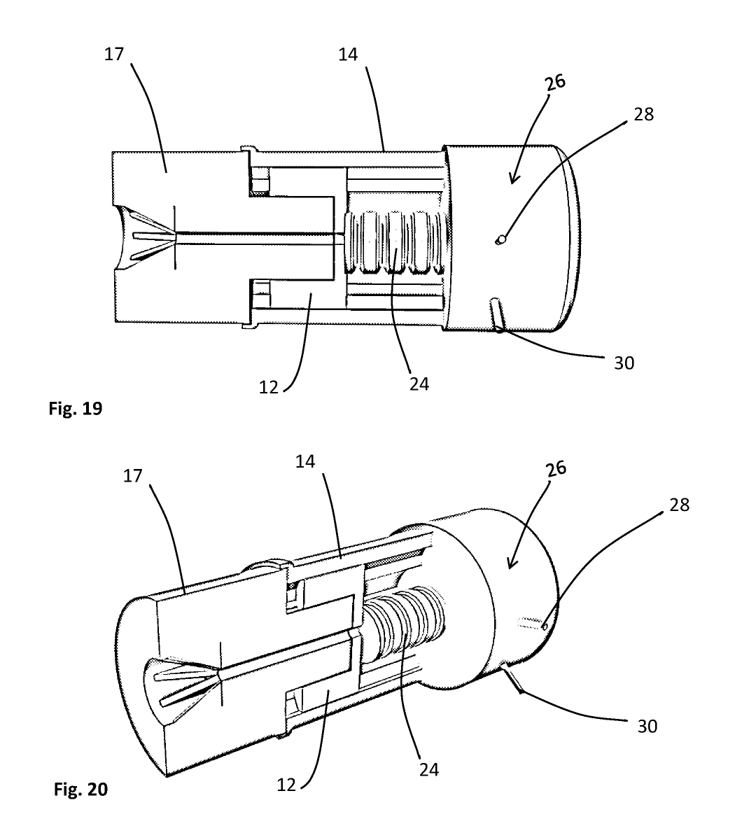

FIGS. 19-22 are cross-sectional side and perspective views illustrating a mechanism for activating switchable locking device 10, according to an exemplary embodiment of the present disclosure.

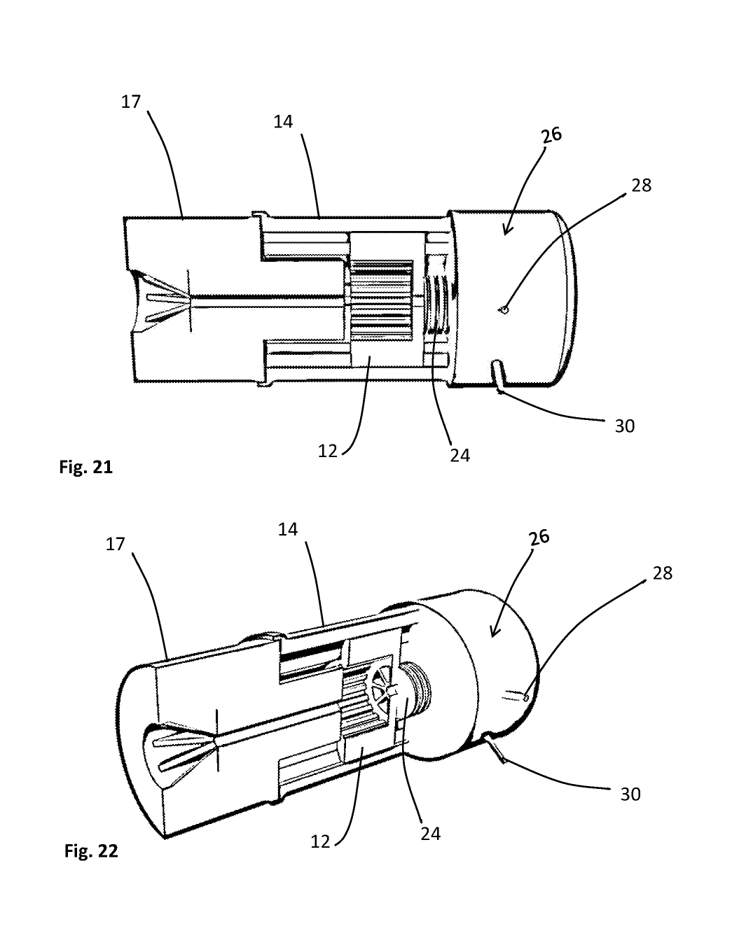

In FIGS. 19-22, internal lock 12 of locking device 10 is activated (i.e., placed between the “ON” and “OFF” states as described above) by means of a hydraulic system including a hydraulic piston 24 operated by a pressure device 26 with pressure in 28 and pressure out 28 ports. FIGS. 19 and 20 illustrate the configuration in which internal lock 12 is in the “ON” state, in which external case 14 is connected to first output shaft (4WD) 17 for transmission of rotation as described above. FIGS. 21-22 illustrate the configuration in which internal lock 12 is in the “OFF” state, in which external case 14 is not connected to first output shaft (4WD) 17 and external case 14 is able to rotate freely as described above.

It will be appreciated that the mechanism for activating switchable locking device 10 is not limited to a hydraulic system. For example, switchable locking device 10 can be activated by an electro-magnetic system or other suitable activation means without departing from the spirit and scope of the invention.

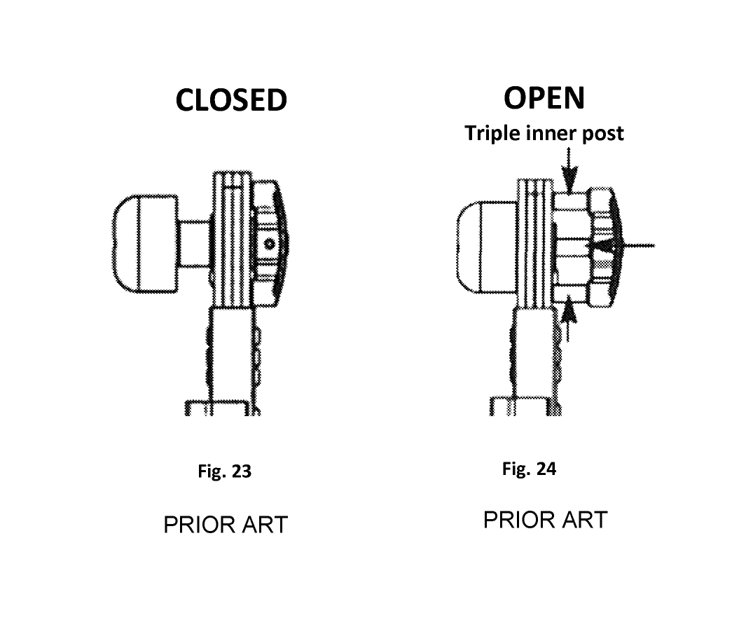

Another application of the switchable gear according to the present disclosure is described below with reference to FIGS. 23-29. In this application, the switchable locking device of the present disclosure is used like a stop or lock device for a static position.

FIGS. 23 and 24 are diagrammatic views illustrating a conventional stop or lock device for a folding multi-position ladder, with the lock device shown in the closed (FIG. 23) and open (FIG. 24) states. These conventional folding ladders can be placed in various adjustable angle positions with push knobs locking a hinge and also adjusted in height using spring loaded “J” locks, as well as use 3-position multi-locking hinges. However, these conventional stop or lock arrangements for folding multi-position ladders suffer from the problems that the adjustments cannot be accomplished with high efficiency and also the degree of adjustment (e.g., the number of angles in which the ladder can be locked) is rather limited.

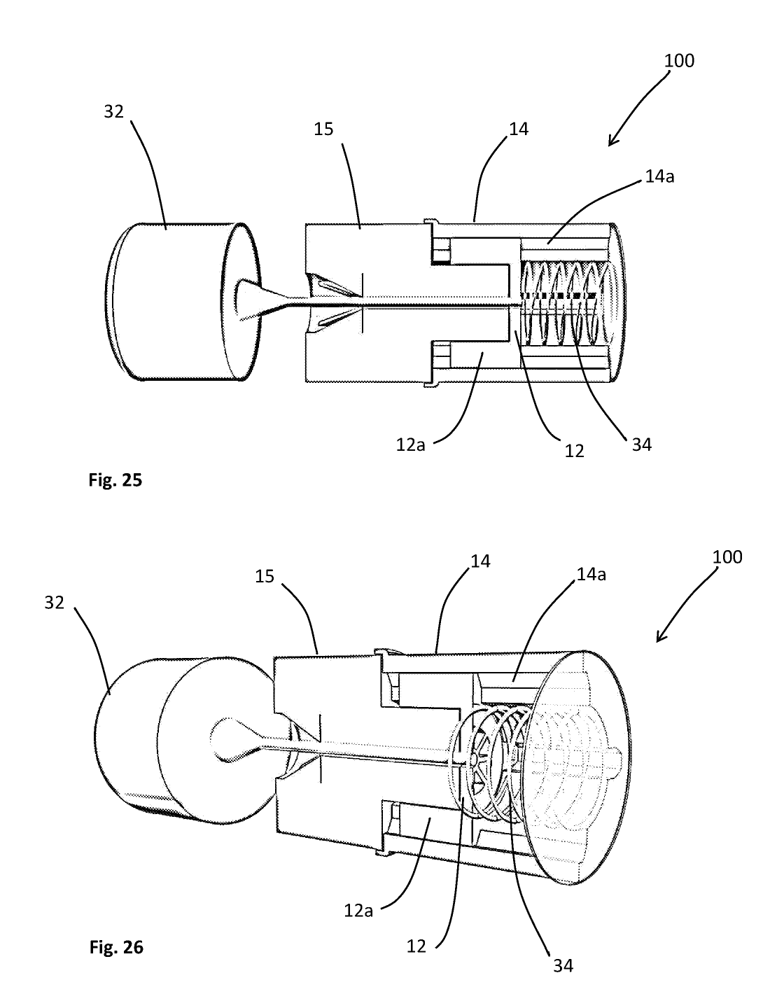

FIGS. 25-28 are rear and side cross-sectional perspective views illustrating an application of the switchable locking device according to the present disclosure as a stop or lock device for a static position, such as for a folding multi-position ladder, which overcomes the foregoing drawbacks in the conventional art.

As shown in FIGS. 25-28, the lock device, generally designated with reference numeral 100, includes a locking gear 12 and case 14 corresponding to the internal gear and external case described above for switchable locking device 10, a main shaft 15, a push knob 32 and spring 34. As best shown in FIG. 29, main shaft 15 is provided with external locking teeth 15a.

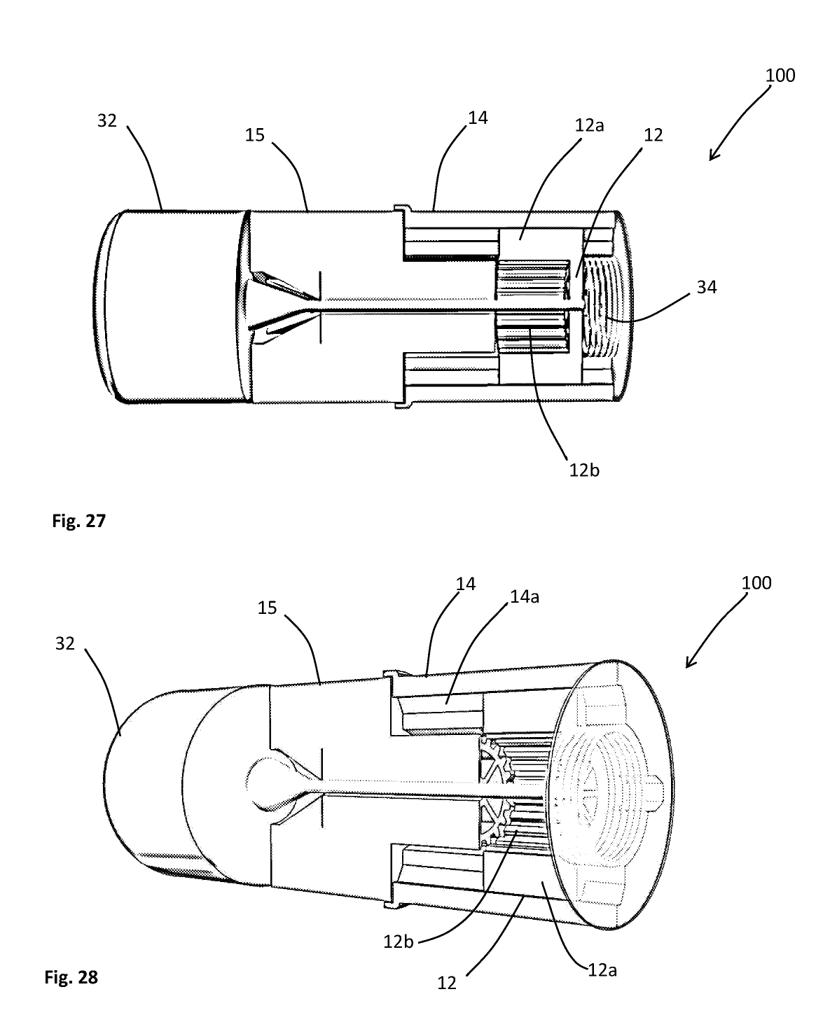

FIGS. 25 and 26 show lock device 100 in a closed state in which locking teeth 12b of locking gear 12 are in meshing engagement with locking teeth 15a of main shaft 15 under the bias of spring 34 (in the left direction of FIG. 27). In this closed state, locking gear 12 is connected to main shaft 15 and case 14 is locked with main shaft 15, thereby preventing case 14 from undergoing rotation relative to main shaft 15.

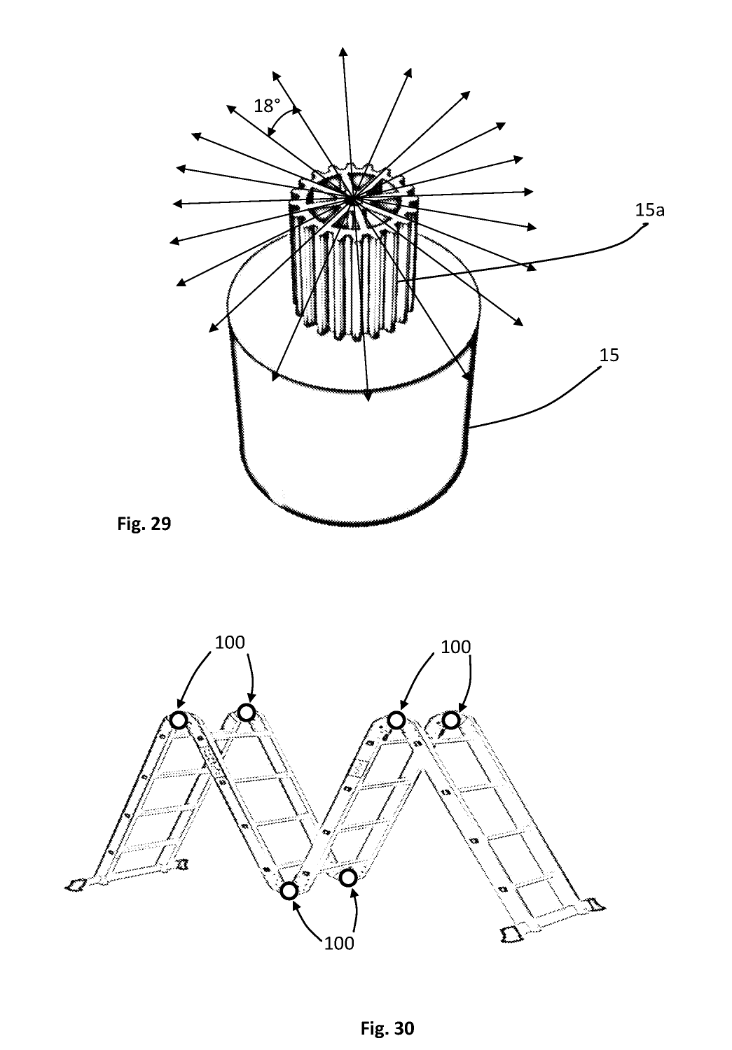

FIGS. 27 and 28 show lock device 100 in an open state in which locking teeth 12b of locking gear 12 are not in meshing engagement with locking teeth 15a of main shaft 15. In this open state, locking gear 12 is not connected to main shaft 15 and case 14 is not locked with main shaft 15, thereby enabling case 14 to freely rotate relative to main shaft 15.

During operation, lock device 100 is activated by manually pushing and releasing push knob 32. When not activated, the lock device 100 is in the closed state as described above (FIGS. 25-26). When activated, the lock device 100 is in the open state as described above (FIGS. 27-28). To activate lock device 100, push knob 32 is manually pushed so that locking gear 12 slides into case 14 (in the right direction of FIG. 27) against the bias of spring 34 until locking gear 12 is disconnected from main shaft 15 (i.e., by releasing the meshing engagement between locking teeth 12b of locking gear 12 and locking teeth 15a of main shaft 15), thereby placing locking device 100 in the open state. While in the open state, case 14 is able to freely rotate relative to main shaft 15 to place it in any of a multitude of selected angular positions relative to main shaft 15 as illustrated in FIG. 29, for example. When the selected angular position is achieved, push knob 32 is released and locking gear 12 is connected back to main shaft 15 by the action of spring 34 and the lock device 100 is again placed in the closed state as described above.

In an exemplary embodiment, locking device 100 according to the present disclosure can be applied at multiple locations of a folding multi-position ladder as illustrated in FIG. 30. Locking device 100 allows one to lock the ladder in a multitude of angular positions (e.g., as shown in FIG. 29) and with high efficiency as compared to conventional ladder lock mechanisms, such as described above with reference to FIGS. 23 and 24.

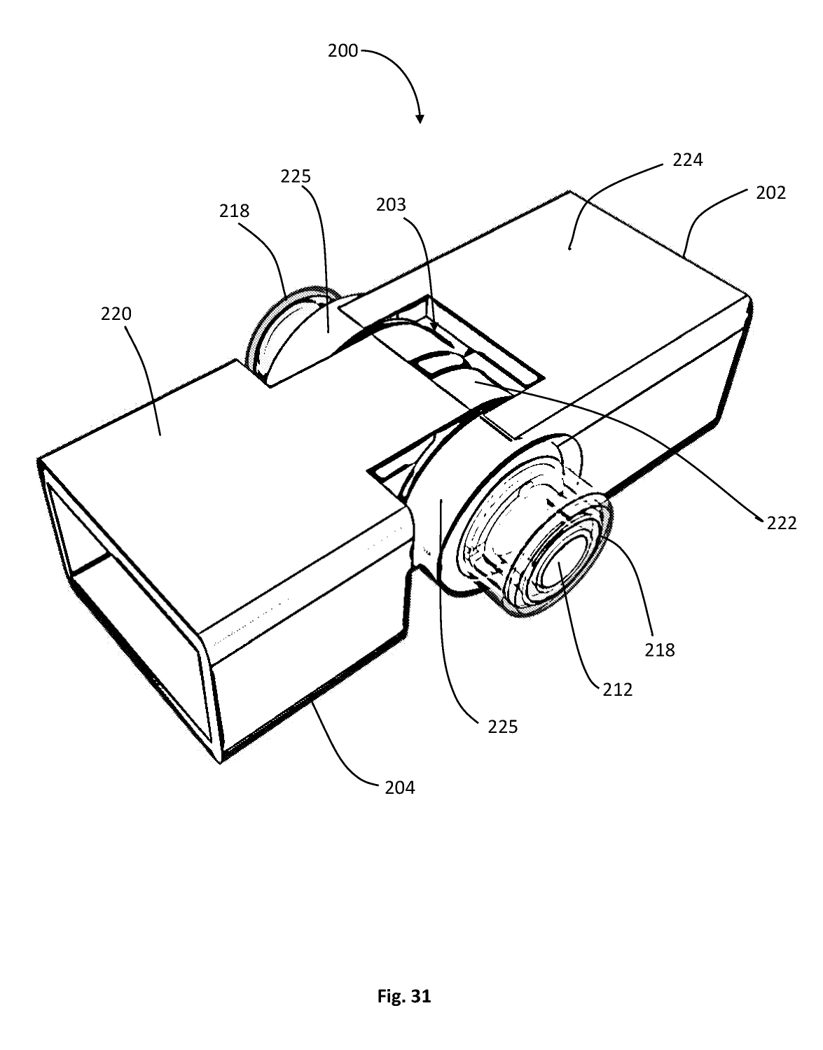

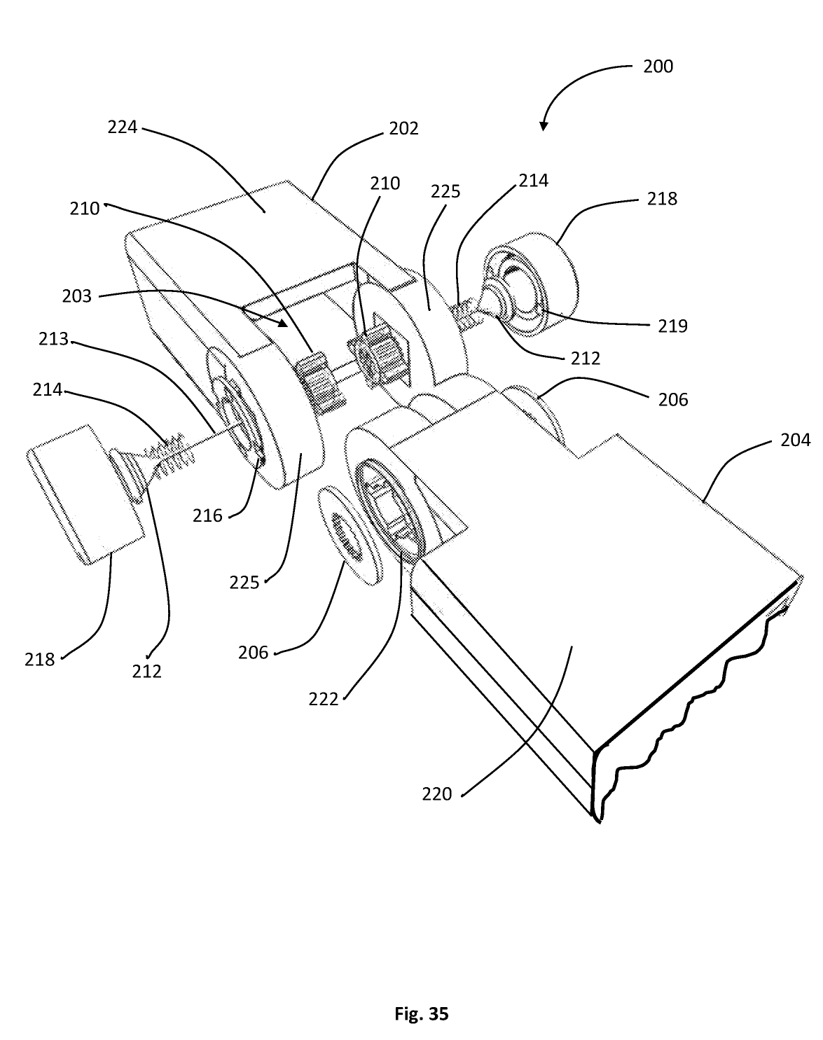

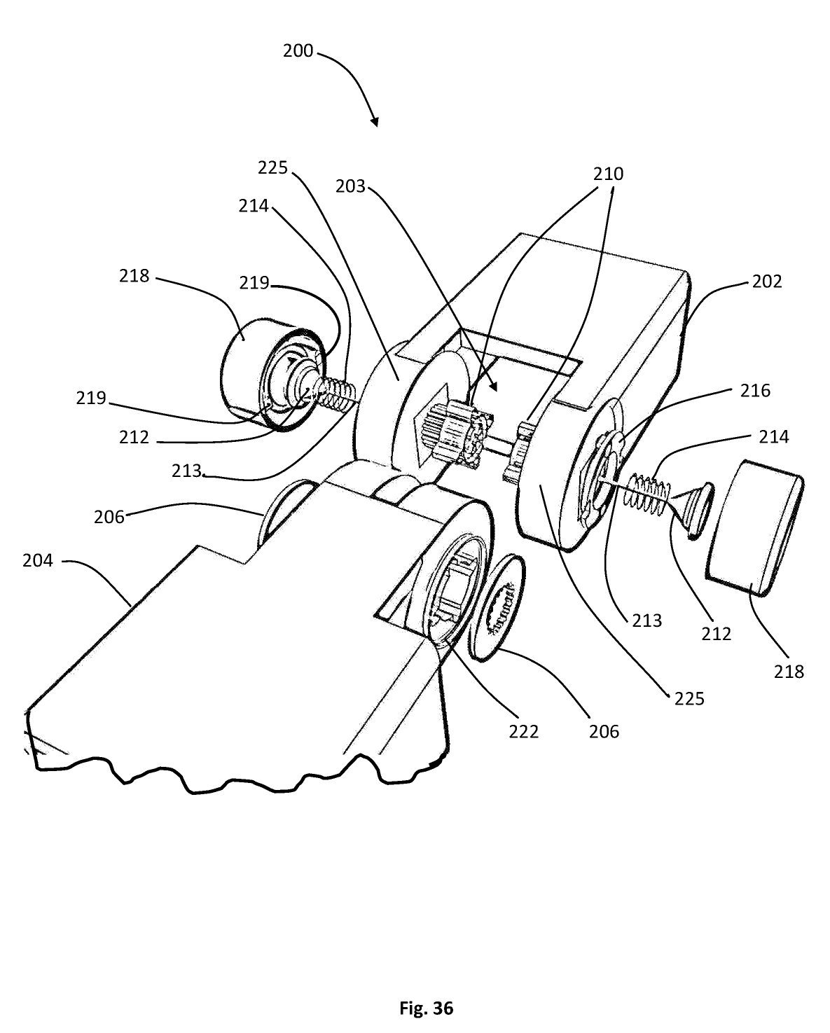

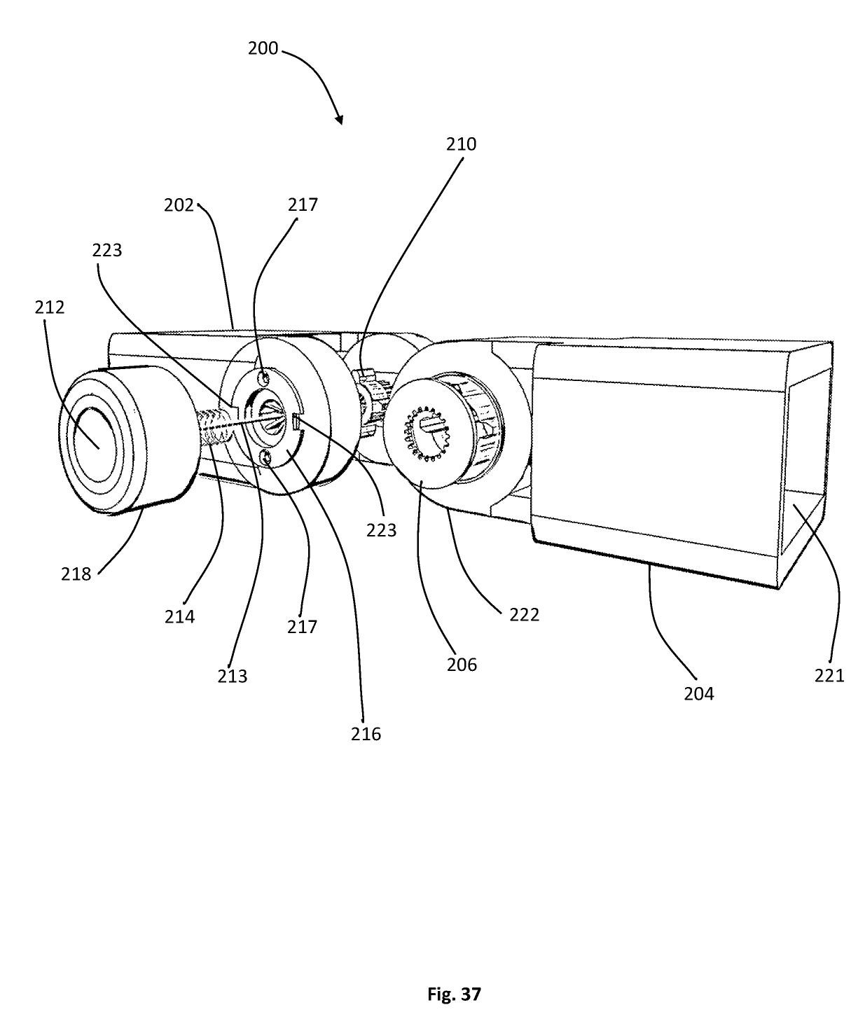

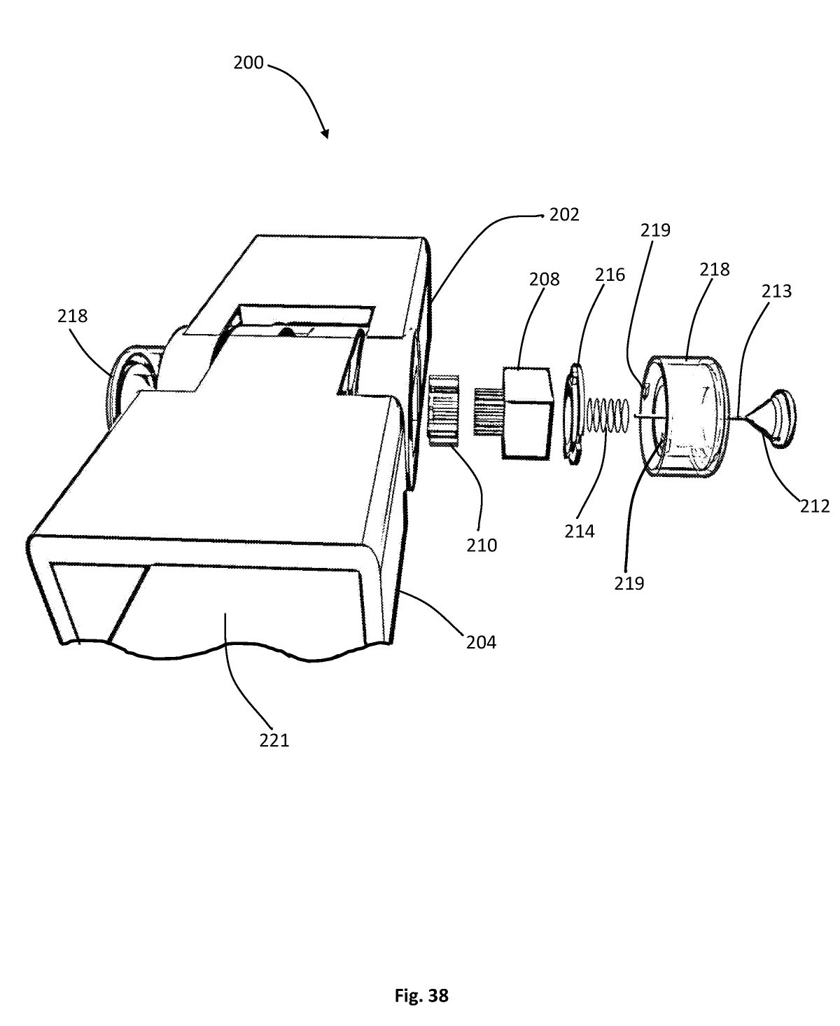

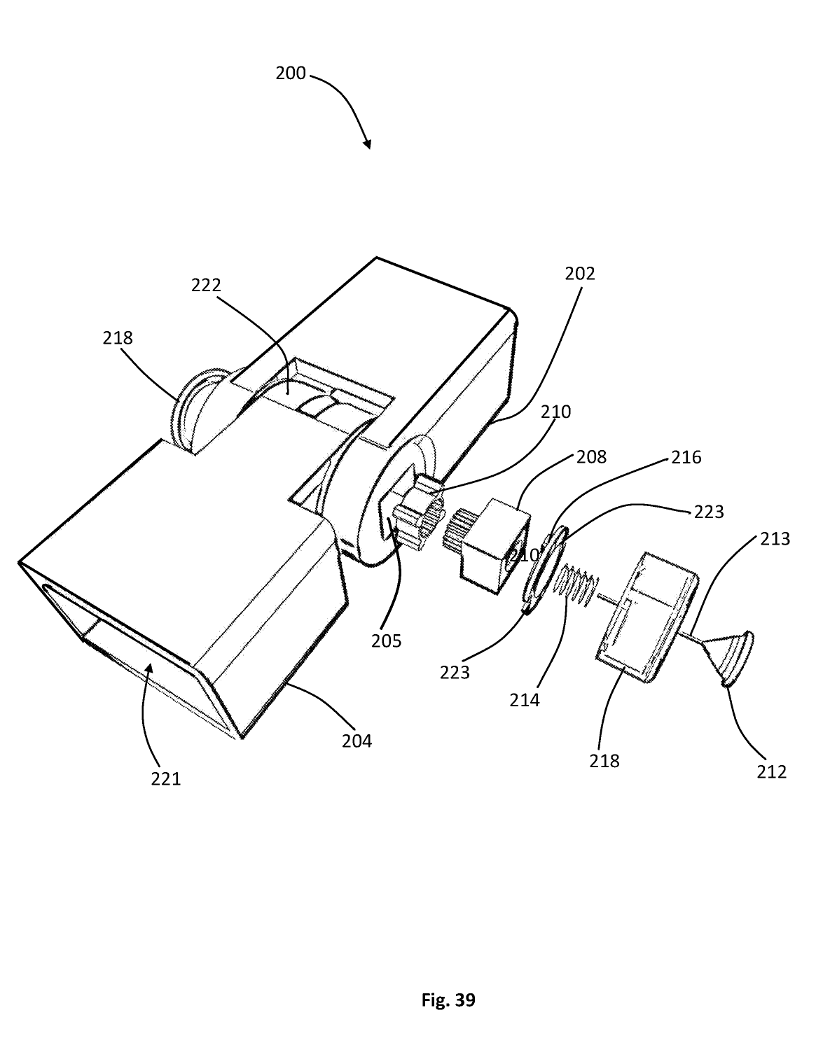

FIGS. 31-39 show another exemplary application of the switchable locking device according to the present invention. In FIGS. 31-39, the switchable locking device, generally designated at 200, is applied to two articulated components in the general form of an articulated arm 220 (first component) and articulated arm 224 (second component) configured to undergo angular movement relative to one another.

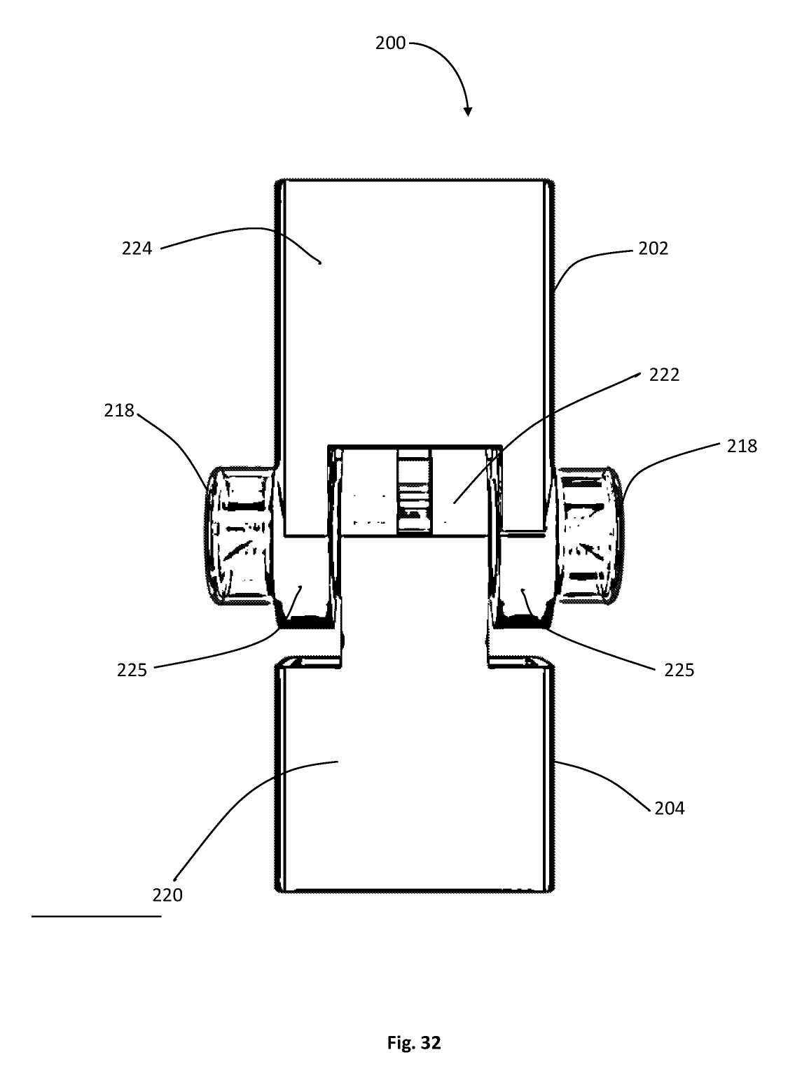

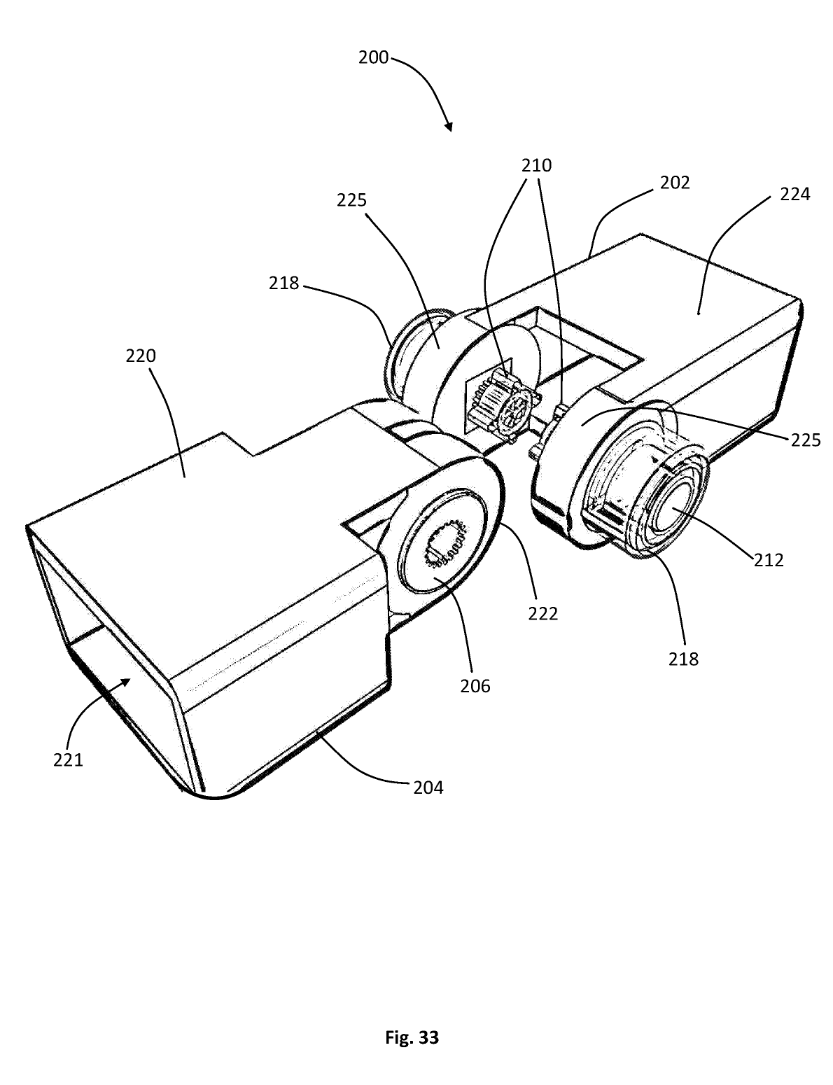

FIG. 31 is a perspective view and FIG. 32 is a top view of switchable locking device 200 shown in an assembled state. Articulated arms 220, 224 include respective arm portions 204, 202 configured to be connected to various elements or objects requiring articulation at various angles relative one another. In this embodiment, arm portions 202, 204 are provided with an opening configured to receive such elements or objects. For example, the openings are configured to receive suitable wooden or metal beams which are integrally connected to arm portions 202, 204 by friction fit, welding, clamping and/or using suitable fasteners such as nails, bolts and/or screws to form a support structure for a scaffold, for example. It will be appreciated that articulated arms 220, 224 can be used for structures other than scaffolds, such as platforms, support beams, etc. By this construction and arrangement, it is appreciated that switchable locking device 200 according to the present invention can hold, support and/or extend any elements or objects attached to articulated arms 220, 224 giving it the ability to position the elements or objects at different angles relative one another.

FIGS. 33-39 illustrate various disassembled states of switchable locking device 200 in partial perspective and exploded views showing the various components and corresponding structural and positional relationships thereof, as further described below.

Articulated arm 220 has a case 222 extending from arm portion 204. Case 222 has the same internal construction as external case 14 described above with reference to FIGS. 1-15. In this embodiment, case 222 is formed in one piece with arm portion 204. Alternatively, case 222 and articulated arm 220, including arm portion 204, may be separate components which are integrally connected together using suitable connecting means. As shown in FIGS. 33, 37, and 38, arm portion 204 is provided with opening 221 for receiving any element/object as described above.

Referring to FIGS. 31-36, articulated arm 224 is provided with two housing portions 225 extending from arm portion 202. In this embodiment, housing portions 225 are formed in one piece with arm portion 202. Alternatively, housing portions 225 and articulated arm 224, including arm portion 202, may be separate components which are integrally connected together using suitable connecting means. Housing portions 225 are spaced-apart from one another to form a space 203 therebetween, as shown in FIGS. 31 and 34-36. Space 203 is configured to receive and accommodate case 222 of articulated arm 222, in the manner shown in FIGS. 31, 32, 38, and 39, so as to permit articulated arms 220, 224 to be moved and placed at various angles relative one another.

Referring to FIGS. 33-39, case 222 is configured to receive and accommodate switchable locks 210 (hereinafter also referred to herein as “internal locks”) each having the same construction (e.g., internal locking teeth) as internal lock 12 described above with reference to FIGS. 1-15. As described above for internal lock 12 and external case 14 in FIGS. 1-15, internal locks 210 and case 222 are configured so as to allow internal locks 210 to slide within and relative to case 222.

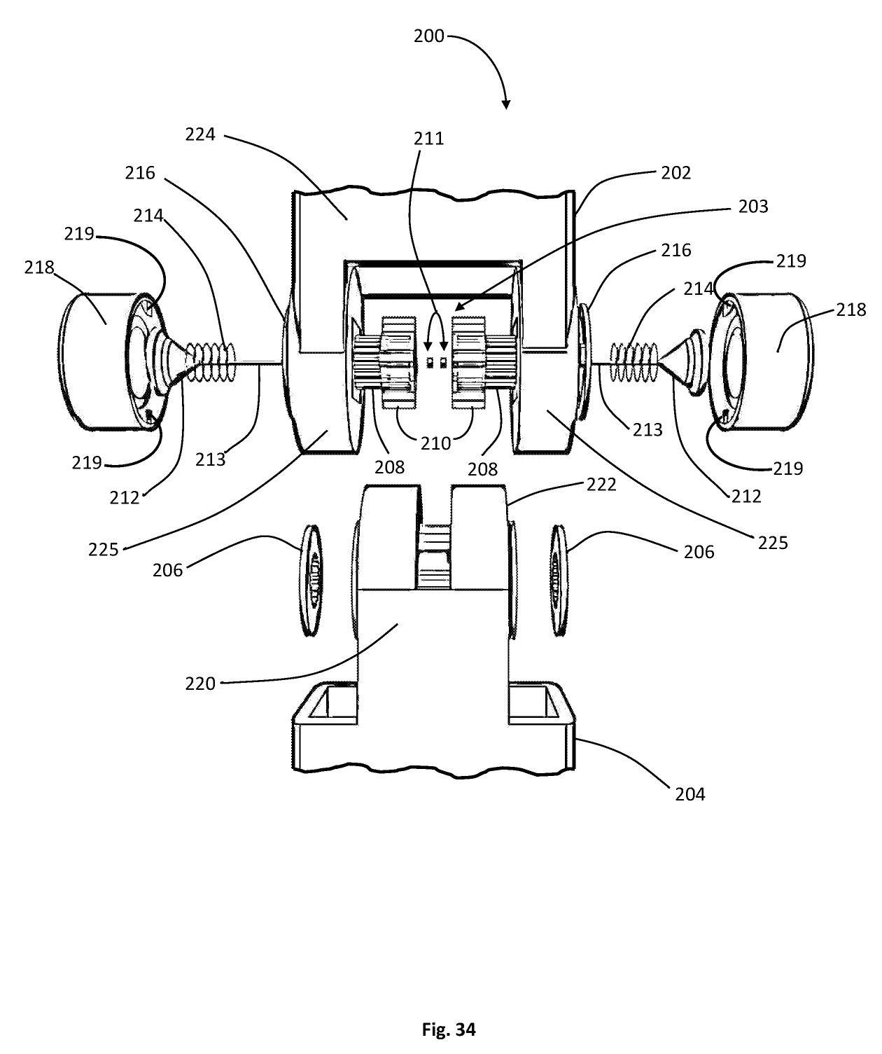

Each housing portion 225 of articulated arm 224 is configured to receive and support therein a main shaft 208 which has the same general construction (e.g., external locking teeth) as main shaft 16 described above with reference to FIGS. 1-15. Each main shaft 208 is supported by and retained in corresponding housing portion 225 by a washer 206 so that the external locking teeth of each main shaft 208 extends into space 203 of articulated arm 224 as shown in FIG. 34, for example. Each washer 206 has internal locking teeth configured to mesh with the external locking teeth of the corresponding main shaft 208. In the assembled state of switchable locking device 200, an outer surface of each washer 206 engages a lip of case 222 while an inner surface of each washer 206 engages an outer side of the corresponding main shaft 208. By this construction, relative sliding movement between articulated arms 220, 224 is prevented.

In the assembled state of switchable locking device 200, a portion of the external locking teeth of each main shaft 208 is configured to extend into case 222 from opposite ends thereof for driving engagement with the internal locking teeth of the corresponding internal gear 210, as shown for example in FIGS. 33-37, when internal locking teeth of internal locks 210 are slid into engagement with the external locking teeth of respective main shafts 208 as further described below. In FIGS. 33-37, main shafts 208 and internal locks 210 are disposed outside of case 222 for illustration purposes only to show how these components are configured for driving engagement with one another while positioned inside of case 222.

Internal locks 210 are configured for undergoing sliding movement within and relative to case 222 to selectively place them into engagement with and disengagement from main shafts 208. In a first state of switchable locking device 200, internal locking teeth of internal locks 210 are disposed in meshing engagement with the external locking teeth of respective main shafts 208. In this first state, articulated arms 220, 224 are placed in a locked state and prevented from undergoing movement relative to one another. In a second state of switchable locking device 200, internal locking teeth of internal locks 210 are completely disengaged from the external locking teeth of respective main shafts 208. In this second state, articulated arms 220, 224 are placed in an unlocked state and are permitted to undergo movement relative one another to position the corresponding elements or objects attached to articulated arms 220, 224 at different angles relative one another.

Switchable locking device 200 is provided with switching means for switching between engagement and disengagement of internal locks 210 and main shafts 208 in the first and second states of switchable gear 200. Referring to FIGS. 34-39, the switching means comprises, for each internal gear 210, a push knob 212, a push rod 213 having one end connected to push knob 212 and another (opposite) end integrally connected to internal gear 210. For each internal gear 210, movement of push knob 212 in a direction towards (first direction) the corresponding housing portion 225 of articulated arm 224 causes internal gear 210 to slide inside case 222 in a direction which results in the disengagement of internal locking teeth of internal gear 210 from the external gears of the corresponding main shaft 208 to achieve the second state of switchable locking device 200 as describe above. Likewise, for each internal gear 210, movement of push knob 212 in a direction away (second direction) from the corresponding housing portion 225 of articulated arm 224 causes internal gear 210 to slide inside case 222 in a direction which results in the internal locking teeth of internal gear 210 coming into meshing engagement with the external gears of the corresponding main shaft 208 to achieve the first state of switchable locking device 200 as describe above.

In an exemplary embodiment, push rods 213 are in the form of threaded rods extending through a through hole of the corresponding main shaft 208 and securely threaded at one end to a threaded hole of the corresponding push knob 212. Each threaded rod 213 also engages the corresponding internal gear 210 and is securely retained thereto by a suitable fastener, (e.g., a threaded nut) denoted with reference numeral 211 in FIG. 34, that is securely engaged with the opposite end of threaded rod 213.

Each push knob 212 is associated with a biasing member 214 configured to bias push knob 212 in the second direction described above (i.e., in a direction away from the corresponding housing portion 225 of articulated arm 224) to maintain switchable locking device 200 in the first state. By this arrangement, pressing push knobs 212 in the first direction described above (i.e., against the bias of springs 214) cause internal locking teeth of internal locks 210 to disengage from external locking teeth of respective main shafts 208 to achieve the second state of switchable locking device 200 (i.e., permitting movement of articulated arms 220, 224 relative one another). In this embodiment, each biasing member 214 is in the form of a coil spring. It is understood, however, that other types of biasing members may be selected to perform the functions described without departing from the spirit and scope of the invention.

Referring to FIGS. 34-39, a stopper element 216 is securely mounted to an outer sidewall of each housing portion 225 for retaining the corresponding main shaft 208 within housing portion 225. Stopper element 216 is mounted to housing portion 225 using any suitable connecting means, such as by screws using holes 217 formed in stopper element 216.

Referring to FIGS. 31-29, removable knob covers 218 are provided for covering the respective push knobs 212. For each push knob 212, knob cover 218 has an opening providing access to a pressing surface of push knob 212, as shown in FIGS. 31, 33, and 37. Knob covers 218 also serve to prevent push knobs 212 from moving side to side and guide them during movement in the first and second directions as described above (i.e., to keep knob covers 218 aligned straight).

As best shown in FIGS. 34, 35, and 38, each knob cover 218 is provided with tab elements 219 configured for engagement with corresponding recessed portions 223 formed in stopper element 216 to removably mount knob cover 218 to stopper element 216.

FIGS. 31 and 32 show switchable locking device 200 in the first state described above, in which articulated arms 220, 224 are placed in a locked state and prevented from undergoing movement relative to one another. This is because in this first state the internal locking teeth of internal locks 210 are disposed in meshing engagement with the external locking teeth of respective main shafts 208 as described above. To switch switchable locking device 200 from the first state to the second state in which articulated arms 220, 224 are permitted to undergo movement relative one another, both push knobs 212 are pressed in the first direction (i.e., against the bias of biasing members 214) to cause internal locking teeth of internal locks 210 to slide inside case 222 until they are completely disengaged from the external locking teeth of respective main shafts 208. While push knobs 220, 224 are maintained in this pressed state, articulated arms 220, 224 can be moved relative one another to position the corresponding elements or objects attached to articulated arms 220, 224 at different preselected angles relative one another. After the desired relative angular position between elements or objects of the corresponding articulated arms 220, 224 is achieved, push knobs 212 are released by the biasing action of biasing members 214 (i.e., are caused to move in the second direction) to place switchable locking device 200 in the first state (i.e., to place articulated arms 220, 224 in the locked state). It will be appreciated that in the first and second states of switchable locking device 200, the engaging and disengaging actions between the main shafts 208 and corresponding internal locks take place inside case 222.

FIGS. 40-56 show embodiments of a positioning and locking system and related applications, according to the present invention.

FIGS. 40-43 and 45A-54B illustrate a positioning and locking system, generally designated by reference numeral 300 (hereinafter also referred to herein as “system”), according to one embodiment of the present invention.

The system 300 comprises a housing formed by a top cover 302, an exterior ring gear 307, and a bottom cover 312, which together define an interior cavity or space for receiving and containing operative components of the system. Disposed within the housing is a gear assembly including plurality of rotatable transmission members 306, an interior ring gear 308, and a central gear drive shaft 309 operatively coupled to a motor 310. The rotatable transmission members 306 are rotatably supported on respective shafts 311 mounted to the bottom cover 312. A bushing 304 is mounted to the drive shaft 309 and positioned within a central opening 302c of the top cover 302. The system further includes one or more switchable locking devices (SLD) (also referred to herein as a “locking device” or “locking devices”) each comprising a tubular case 303 and a switchable lock element 305 (also referred to herein as a “switchable lock” or “locking element”) associated with a respective rotatable transmission member 306. Each locking element 305 is operatively connected to an actuator 320 for selectively moving the locking element 305 between locked and unlocked states/positions of the SLD. The housing components are secured together by straps 313 and associated fasteners 316, and the motor 310 and drive shaft 309 are mounted to the bottom cover 312 via a retaining pin 314 and a mounting plate 315. Together, these components define the positioning and locking system 300 as illustrated in FIGS. 40-43 and 45A-54B.

Referring to FIGS. 41-43, the exterior ring gear 307 is interposed between the top cover 302 and the bottom cover 312, such that a top peripheral surface 307b of the ring gear engages a corresponding bottom peripheral surface 302d of the top cover, and a bottom peripheral surface 307c of the ring gear engages a corresponding top peripheral surface 312b of the bottom cover. These interfaces provide controlled frictional engagement that allows rotation of the ring gear 307 relative to the housing while maintaining axial alignment. The outer peripheral surfaces 302e, 307d, and 312c are flush with one another to form a continuous exterior surface of the housing, as shown in FIG. 41.

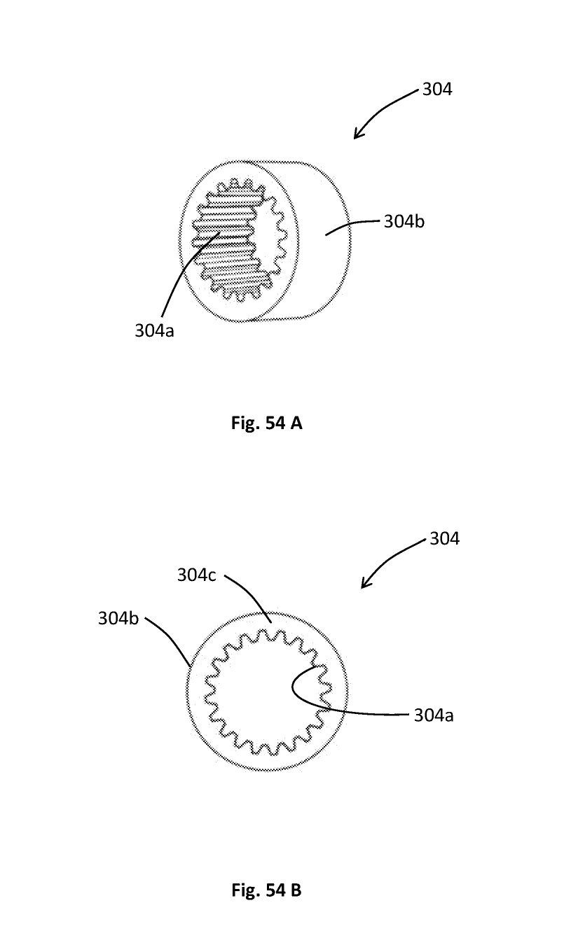

As shown in FIGS. 40 and 31, the top cover 302 includes a central opening 302c, through which a central gear drive shaft 309 extends. The drive shaft 309 is a tubular output shaft configured to transmit rotational motion to an external/output device. The bushing 304 is disposed within the central opening 302c and is mounted on the shaft 309. As shown in FIGS. 54A and 54B, the bushing 304 includes internal teeth 304a that engage corresponding external teeth of the shaft 309 to ensure rotational coupling. During rotation of the shaft 309, the outer surface 304b of the bushing 304 is configured to engage an inner surface 302g of the opening 302c with slight friction, thereby maintaining concentric alignment of the shaft and preventing lateral movement during rotation.

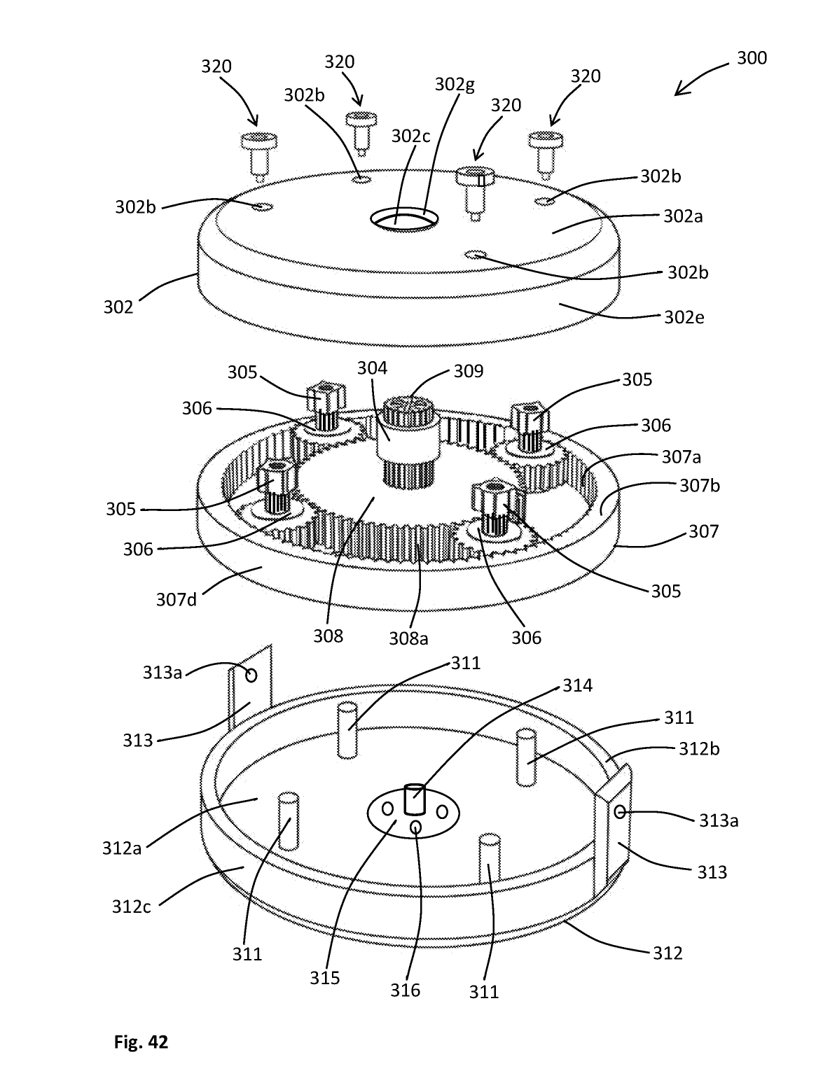

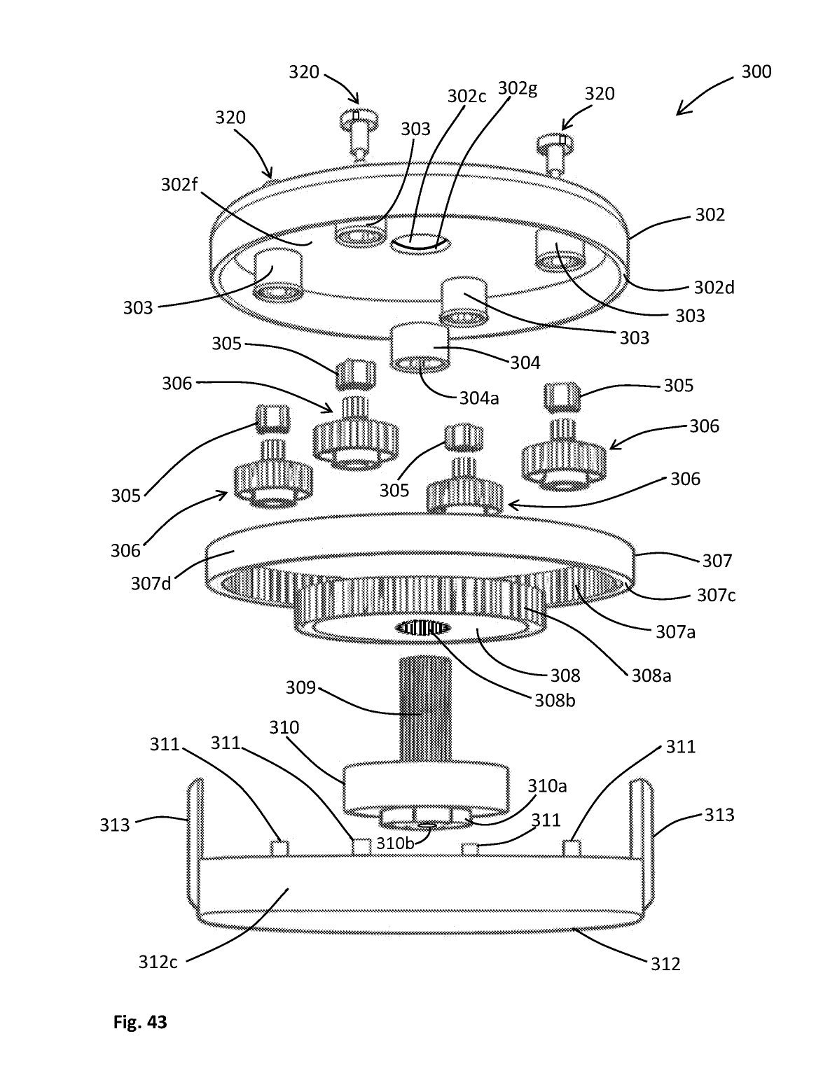

Referring to FIGS. 42 and 43, each of the rotatable transmission members 306 comprises a compound secondary gear as further described below. The interior ring gear 308 is mounted on the shaft 309. The exterior ring gear 307 and a plurality of the secondary compound gears 306 are arranged circumferentially around the interior ring gear 308. The interior ring gear 308 includes external teeth 308a that mesh with corresponding external teeth of the secondary gears 306, as well as a toothed bore 308b that engages the shaft 309. The exterior ring gear 307 includes internal teeth 307a that also mesh with the secondary gears 306.

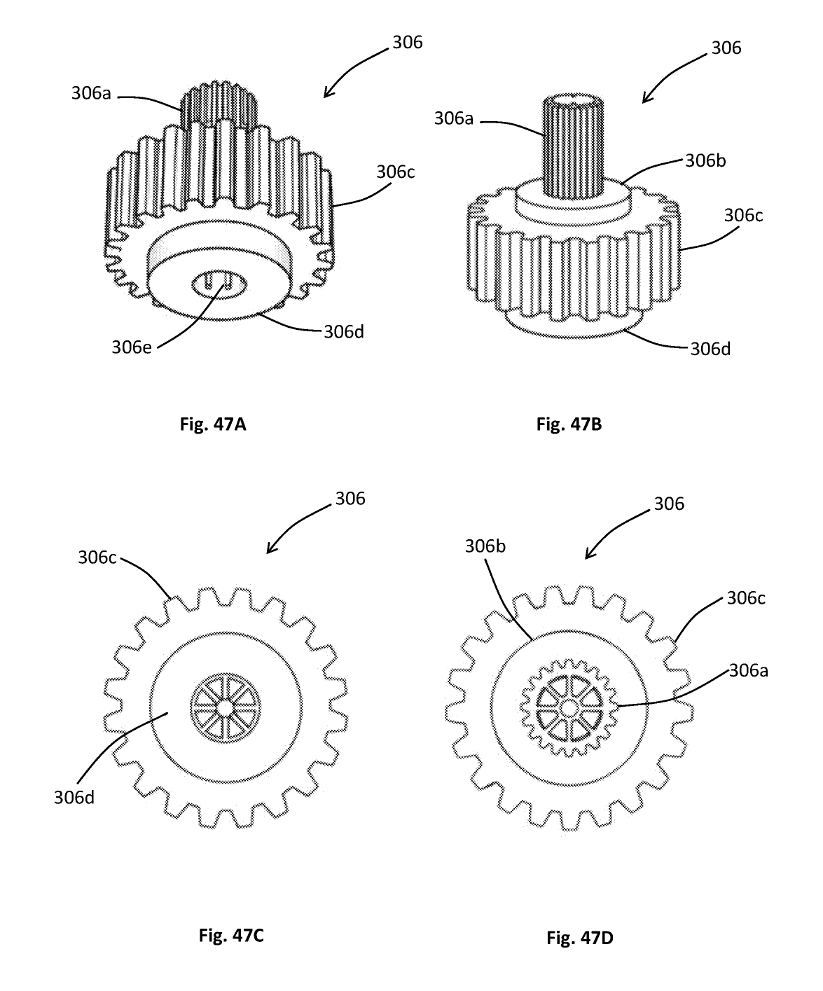

As shown in FIGS. 47A-47D, each secondary gear 306 includes a pinion portion 306a having external teeth, a spur gear portion 306c having external teeth, a shaft portion 306b, and a cylindrical mounting portion 306d having an opening 306e configured to receive a support shaft 311. The support shafts 311 are mounted to an interior surface 312a of the bottom cover 312 and act as axles that support rotational movement of the secondary gears 306.

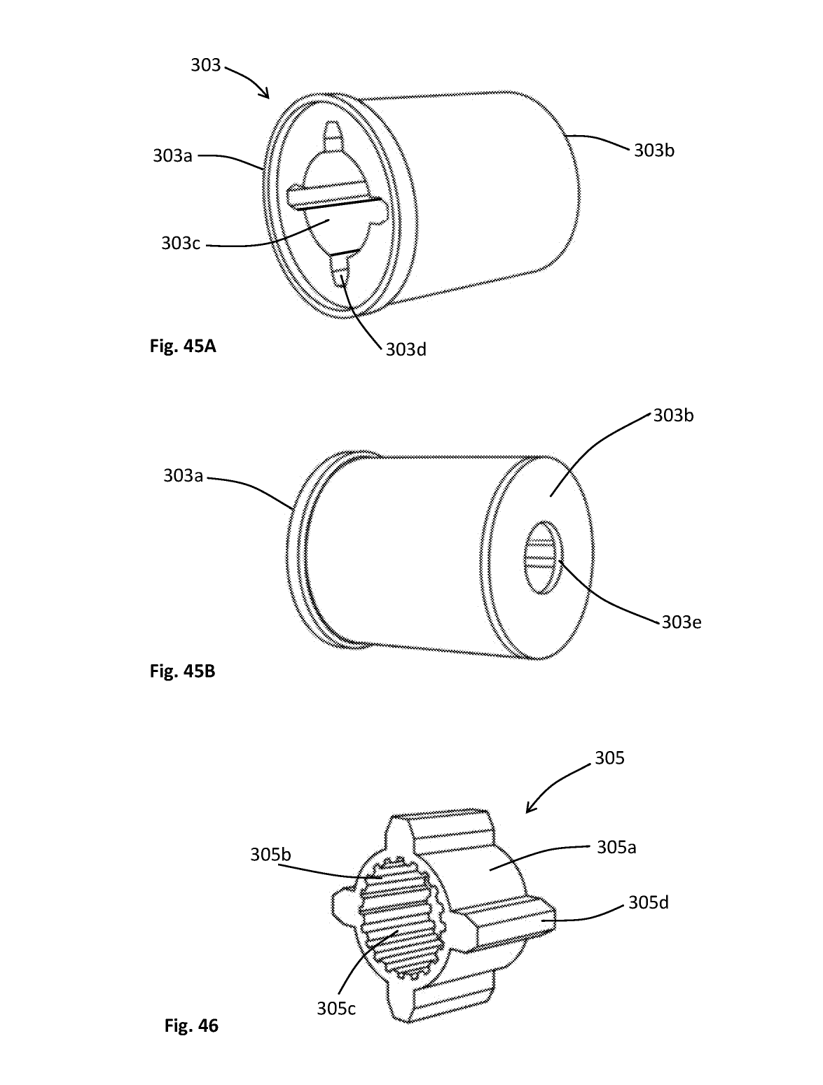

Each secondary gear 306 is associated with a switchable locking device (SLD) comprising one of the locking elements 305 and one of the tubular cases 303. As shown in FIGS. 45A, 45B, and 46, the tubular case 303 is mounted to an inner surface 302f of the top cover 302 and defines an internal cavity 303c within which the locking element 305 is configured to be disposed during operation of the system 300. The locking element 305 includes inner locking teeth 305c configured to engage the external teeth of the pinion portion 306a of a corresponding secondary gear 306, as well as outer locking teeth 305d that engage slots 303d formed in the tubular case 303 to prevent rotation of the locking element relative to the housing.

In the assembled state of the system 300, the locking element 305 is continuously disposed within the tubular case 303 and remains guided therein in both the unlocked and locked states of the SLD. In particular, the outer locking teeth 305d of the locking element 305 are received within and engage corresponding slots 303d formed in the tubular case 303, thereby constraining the locking element 305 against rotational movement while permitting axial displacement relative to the tubular case 303. This arrangement ensures that the locking element 305 maintains proper alignment for selective engagement and disengagement with the associated secondary gear 306.

Further in the assembled configuration, the pinion portion 306a of the secondary gear 306 extends axially into an open end 303a of the tubular case 303 and remains positioned therein for selective engagement with the inner locking teeth 305c of the locking element 305 when the SLD is in the locked state. The shaft portion 306b of the secondary gear 306, which surrounds the pinion portion 306a as shown in FIG. 47B, likewise extends at least partially into the open end 303a of the tubular case 303. An outer peripheral surface of the shaft portion 306b is configured to engage an inner peripheral surface of the tubular case 303 with a slight clearance or light frictional contact. This interface provides radial support and alignment of the secondary gear 306 relative to the tubular case 303, while permitting free rotational movement of the secondary gear 306 relative to the tubular case 303 when the locking element 305 is in the unlocked state. In this manner, during the unlocked state of the SLD, the secondary gear 306 is allowed to rotate relative to the tubular case 303 with minimal resistance, while in the locked state, axial movement of the locking element 305 into engagement with the pinion portion 306a prevents rotation of the secondary gear 306 and thereby immobilizes the gear assembly.

As noted above, the locking element 305 is axially movable within the tubular case 303 between a disengaged position and an engaged position. In the disengaged position, the locking element 305 is spaced from the secondary gear 306, allowing free rotation of the gear assembly. In the engaged position, the locking element 305 is moved into engagement with the pinion portion 306a of the secondary gear, thereby preventing rotation of the secondary gear and, consequently, the entire gear assembly. FIG. 42 illustrates the locking elements 305 in engaged positions with corresponding secondary gears 306, while in FIG. 43 the locking elements 305 are shown in disengaged positions with corresponding secondary gears 306.

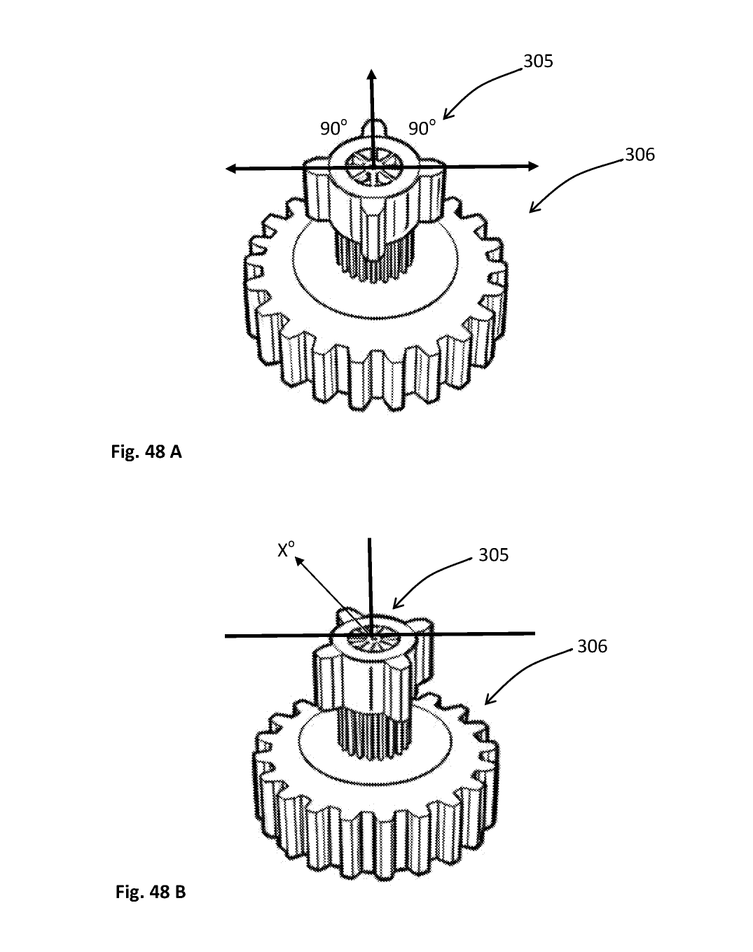

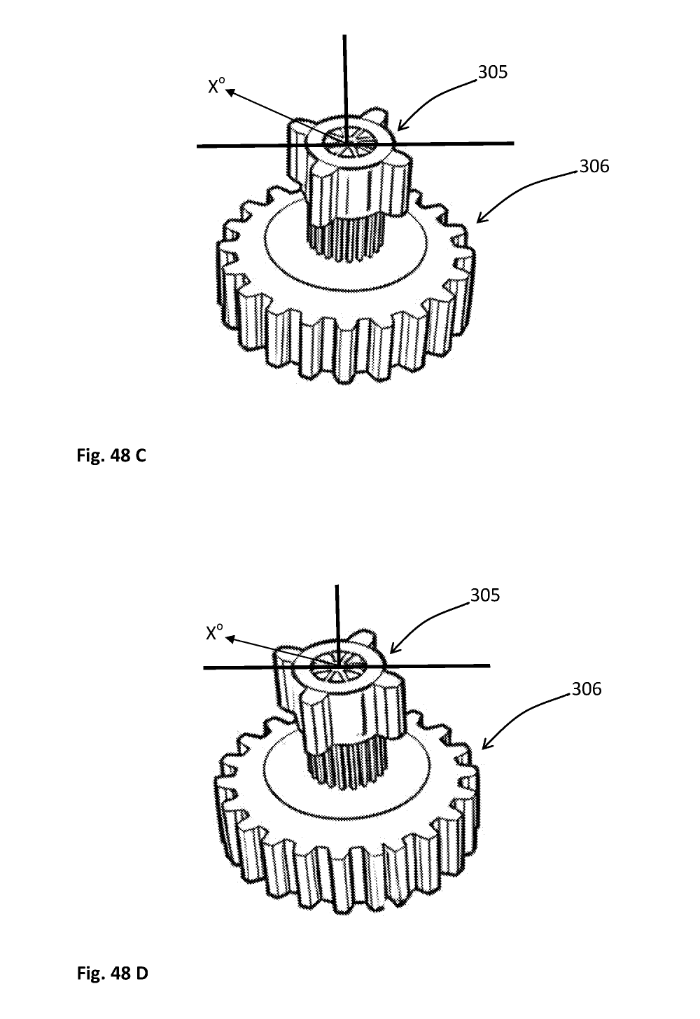

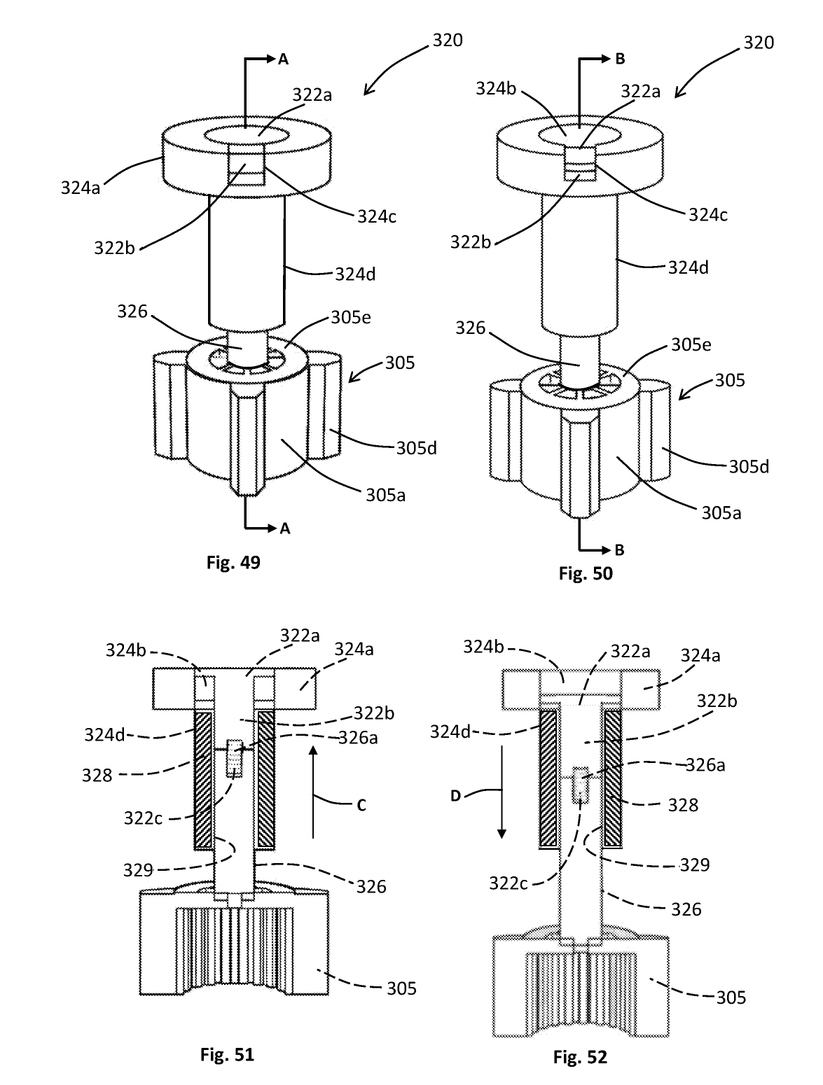

Axial movement of each locking element 305 is controlled by a corresponding actuator 320. In the illustrated embodiment, the locking element 305 of each SLD is integrally connected to the actuator 320, and more specifically to a plunger 326 thereof, such as by welding, high-strength adhesive bonding, threaded engagement, or other suitable fastening means, as shown in FIGS. 49-53. In FIGS. 42-44, the locking element 305 is not shown connected to the plunger 326 of the actuator 320 for ease of illustration of the component arrangement. In particular, as noted above, in FIG. 42 the locking elements 305 are shown connected with the secondary gear 306 to illustrate the engaged position, whereas in FIG. 43 the locking element 305 are shown disconnected from the secondary gear 306 to illustrate the disengaged position. In these figures, the omission of the connection between the locking element 305 and the actuator 320 is solely for clarity of illustration. FIGS. 49-52 more clearly illustrate the integral connection between the locking element 305 and the actuator 320 via the plunger 326, as well as the corresponding axial movement between locked and unlocked states. Additionally, in FIGS. 48A-48D, the locking element 305 is shown engaged with the secondary gear 306 without the plunger 326 or actuator 320 being depicted, for the purpose of illustrating various exemplary angular locking positions of the SLD.

Referring to FIGS. 49-53, the actuator 320 in the present embodiment is a solenoid actuator including a push actuator 322, a core 324, a plunger 326, a magnetic coil 328, and a guide 329. The push actuator 322 includes a head section 322a, a body section 322b extending from the head section 322a, and a threaded section 322c extending from the body section 322b, as shown in FIGS. 51-53. The head section 322a is accessible from the top surface 302a of the top cover 302, as illustrated in FIGS. 40-41, thereby allowing manual actuation when desired.

The core 324 includes a tubular head section 324a, a hole 324b formed in the tubular head section 324a for receiving the push actuator 322, a slot 324c formed in the tubular head section 324a, and a tubular body section 324d extending from the tubular head section 324a. The slot 324c, as shown in FIGS. 41-43 and 49-53, provides access to the head section 322a, thereby enabling manual or tool-assisted actuation of the push actuator 322 to move the locking element 305 into and out of engagement with the secondary gear 306, as described herein.

The plunger 326 includes a threaded hole 326a formed at a top (first) end thereof, which is configured to threadedly engage the threaded section 322c of the push actuator 322 so as to integrally connect the push actuator 322 and the plunger 326 for conjoint axial movement. The plunger 326 further includes a bottom (second) end 326b that is integrally connected to an end of the locking element 305, such that axial movement of the plunger 326 results in corresponding axial movement of the locking element 305.

The guide 329 is provided along an inner wall of the tubular body section 324d of the core 324 and is configured to guide axial movement of the plunger 326 and maintain alignment thereof during operation. The magnetic coil 328 is disposed within the actuator and surrounds the guide 329, such that, upon application of electrical current to the magnetic coil 328, a magnetic field is generated to actuate the plunger 326 and thereby move the locking element 305 between engaged and disengaged positions as described above. Thus, plunger 326 is mechanically coupled to the locking element 305 and is configured to move axially in response to activation of the actuator. When electrical current is supplied to the magnetic coil 328, a magnetic field is generated that causes the plunger 326 to move in a selected direction, thereby moving the locking element 305 either into engagement with or out of engagement from the secondary gear 306.

Referring again to FIG. 42, the secondary gears 306 are arranged circumferentially around the interior ring gear 308 and are angularly offset, or phase-shifted, relative to one another such that each secondary gear 306 corresponds to a distinct angular alignment condition within the system 300. In operation, rotational input from the motor 310 is transmitted through the drive shaft 309 to the interior ring gear 308, which in turn drives the secondary gears 306, the latter meshing with both the interior ring gear 308 and the exterior ring gear 307 to distribute torque throughout the system. Due to the phase-offset arrangement, each secondary gear 306 reaches alignment with its corresponding locking position at a different angular orientation of the system, thereby defining a plurality of discrete angular locking positions.

A key aspect of the invention is that, although multiple secondary gears 306 and corresponding locking elements 305 are provided, only a single locking element 305 is selectively actuated to engage a corresponding secondary gear 306 at any given time, while the remaining secondary gears remain disengaged and free to rotate. This selective, single-gear engagement mechanism enables the system to lock at a desired angular position based on which secondary gear 306 is aligned with the locking element 305 at that position. Because each secondary gear 306 is phase-offset, the system achieves multiple distinct angular locking positions without requiring simultaneous engagement of multiple locking elements, thereby simplifying the locking mechanism while maintaining high positional resolution.

FIGS. 48A-48D illustrate exemplary angular indexing schemes achievable through the phase-offset configuration of the secondary gears 306. In particular, FIG. 48A represents a first mode in which locking occurs at full-step angular positions, corresponding to integer increments of a base angular pitch. FIG. 48B represents a second mode in which the secondary gears 306 are offset to provide half-step angular positions, such as intermediate positions between the full-step increments. FIG. 48C represents a third mode in which the system is configured to provide fractional angular positions, such as increments of 3/8 of the base pitch, while FIG. 48D represents a fourth mode in which quarter-step angular positions are provided. These modes are exemplary and illustrate that each secondary gear 306 may be configured to correspond to a different angular indexing pattern, such that, as the system rotates, different secondary gears sequentially reach alignment with their respective locking positions.

When a desired angular position is to be achieved, the system identifies or inherently reaches the secondary gear 306 that is aligned with that target angular position, and the corresponding locking element 305 is actuated to engage that secondary gear, thereby locking the system in that precise orientation. Because only one locking element 305 is engaged at a time, locking is exclusive and does not involve simultaneous multi-gear engagement. This configuration allows the system to achieve high-resolution angular positioning by selecting the appropriate secondary gear based on angular alignment rather than by increasing mechanical complexity through compound gearing.

Moreover, the system is inherently scalable, in that additional secondary gears 306 may be incorporated and arranged with corresponding phase offsets to provide finer or customized angular increments. For example, additional secondary gears may be configured to provide locking positions corresponding to fractional increments such as one-eighth, one-sixteenth, or other subdivisions of the base angular pitch. Each such additional secondary gear is phase-offset so that it aligns with its respective fractional locking position at a predictable angular orientation. In this manner, the system can be configured to achieve virtually arbitrary angular resolution depending on the number and arrangement of the secondary gears, while maintaining a compact and mechanically efficient architecture.

According to a feature of the present invention, the system 300 is configured to operate selectively in both a motor-driven mode and a manual mode, thereby providing operational flexibility as well as fail-safe functionality.

In the motor-driven mode, electrical power is supplied to the motor 310, which drives rotation of the central shaft 309. Rotation of the shaft 309 in turn drives the interior ring gear 308, which transmits rotational motion to the secondary gears 306 that mesh with both the interior ring gear 308 and the exterior ring gear 307, thereby causing corresponding rotation of the exterior ring gear 307 and any output device coupled thereto. During this mode, the switchable locking device (SLD) remains in an unlocked state, with the locking element 305 disengaged from the corresponding secondary gear 306, thereby allowing free rotation of the gear assembly. When a desired angular position, as described above with reference to the phase-offset secondary gears 306, is reached, the actuator 320 is energized to move the plunger 326 axially so as to bring the locking element 305 into engagement with the corresponding secondary gear 306. This engagement prevents rotation of the engaged secondary gear 306 and, consequently, immobilizes the interior ring gear 308, the exterior ring gear 307, and the shaft 309, thereby locking the system 300 in the selected angular position.

In the manual mode, which is particularly advantageous in the event of loss of electrical power or when manual adjustment is desired, the system 300 may be operated without energizing the motor 310. In this mode, the shaft 309 may be rotated manually, for example by applying a tool or manual force to an accessible portion of the system, such as through the opening provided by slot 324c in the core 324 to access the head section 322a of the push actuator 322, or directly to an exposed portion of the shaft 309 depending on the implementation. During manual positioning, the locking element 305 is maintained in the disengaged position to permit free rotation of the gear assembly. Once the desired angular position is achieved, the user may manually actuate the push actuator 322a, either directly or via a tool through slot 324c, thereby causing axial movement of the plunger 326 and corresponding engagement of the locking element 305 with the aligned secondary gear 306 to lock the system in place.

Because the locking function is achieved through direct mechanical engagement between the locking element 305 and the secondary gear 306, the system is capable of maintaining the selected angular position without requiring continuous electrical power, thereby providing a zero-power holding condition. Additionally, the presence of multiple secondary gears 306 arranged circumferentially within the system allows applied loads to be distributed across multiple structural paths within the gear assembly, even though only one secondary gear is selectively locked at a given time, thereby reducing localized stress concentrations, improving load-bearing capability, and enhancing overall durability and reliability of the system.

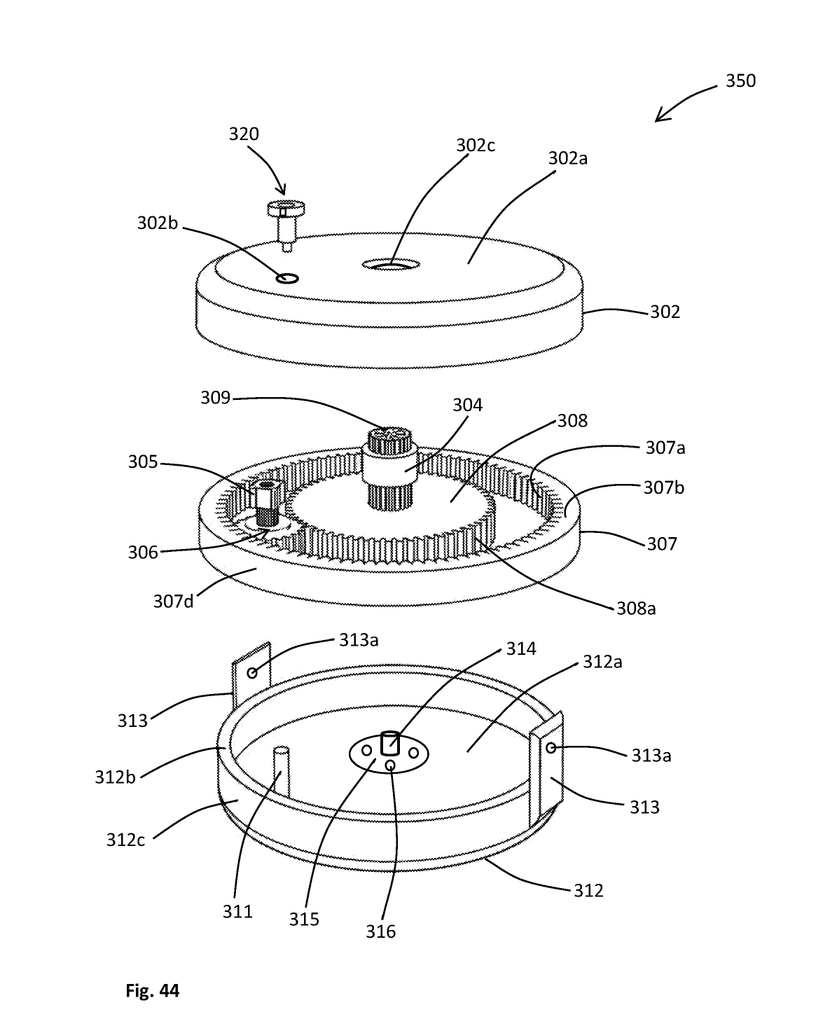

FIG. 44 illustrates another embodiment of the system, generally designated by reference number 350, in which the positioning and locking system 300 is configured with only one secondary gear 306 supported on a single shaft 311, and a single switchable locking device (SLD) including a tubular case 303 and a locking element 305 associated with one actuator 320. In this embodiment, all other components of the system, including the housing formed by the top cover 302 and bottom cover 312, the exterior ring gear 307, the interior ring gear 308, the central drive shaft 309, the motor 310, and the bushing 304, are substantially as described above with respect to the multi-gear embodiment of system 300.

In operation of the single-gear embodiment 350, rotational motion is imparted by the motor 310 to the shaft 309, which drives the interior ring gear 308. The interior ring gear 308, in turn, transmits motion to the single secondary gear 306, which meshes with both the interior ring gear 308 and the exterior ring gear 307, thereby causing rotation of the exterior ring gear 307 and any associated output structure. When the locking element 305 is in a disengaged position, the secondary gear 306 is free to rotate, allowing continuous positioning of the system. When locking is desired, the actuator 320 is activated to move the locking element 305 axially into engagement with the pinion portion 306a of the secondary gear 306, thereby preventing rotation of the secondary gear and, consequently, immobilizing the interior ring gear 308, the exterior ring gear 307, and the shaft 309. Because only a single secondary gear is present in this embodiment, the system provides a single set of discrete locking positions corresponding to the angular alignment of that gear, and does not provide the multi-resolution indexing capability of the multi-gear embodiment. However, this configuration offers a simpler mechanical structure, reduced component count, and may be advantageous in applications where a fixed angular indexing scheme is sufficient.

The number and arrangement of SLDs, actuators and secondary gears in the system may be selectively varied to achieve different performance characteristics, including angular resolution, load distribution, redundancy, and overall system robustness. In embodiments including multiple secondary gears arranged circumferentially and phase-offset relative to one another, such as for the system 300, the system is capable of achieving higher angular resolution by providing multiple distinct locking positions corresponding to different angular alignments of the respective gears. Increasing the number of secondary gears allows for finer angular increments and more precise positioning, as each additional gear may be configured to correspond to a different fractional subdivision of a base angular pitch. Furthermore, multiple secondary gears provide improved load distribution, as forces applied to the system may be transmitted through multiple gear interfaces, thereby reducing stress concentrations and enhancing durability. Conversely, embodiments with fewer secondary gears, such as the system 350, provide a more compact and simplified structure with fewer components, reduced manufacturing complexity, and potentially lower cost, albeit with reduced angular resolution and redundancy.

In the embodiments of the system according to the present invention, the motor 310 and the actuator 320 may be powered by the same power source or by different power sources, without departing from the spirit and scope of the present invention.

The motor 310 may be powered by a variety of electrical power sources depending on the intended application and operating environment of the system 300. In one embodiment, the motor 310 is electrically coupled to an onboard battery, such as a rechargeable lithium-ion or lithium-polymer battery pack, enabling fully self-contained operation of the system. In another embodiment, the motor 310 is powered by an external power supply, such as a wired connection to a mains electrical source (e.g., AC power converted to DC via a power converter), or a remote DC power source provided through a cable or harness. In further embodiments, the motor 310 may be powered through an electronic control module, such as module 560 in FIG. 56 as further described below, which may include power regulation circuitry, drivers, and control electronics configured to selectively supply voltage and current to the motor 310. In still other implementations, the motor 310 may be powered by alternative energy sources, such as solar panels, fuel cells, or other energy harvesting systems, particularly in remote or autonomous installations. The power supplied to the motor 310 may be controlled through manual switches, programmable controllers, or communication interfaces, thereby allowing selective activation, speed control, and directional control of the motor in accordance with system requirements.

The actuator 320 may be powered by a battery, an external electrical power supply, or an electronic control system. In the unlocked state, the actuator causes the plunger 326 to move upward in the direction indicated by arrow C in FIG. 51, thereby disengaging the locking element 305 from the secondary gear 306. In the locked state, the actuator causes the plunger 326 to move downward in the direction indicated by arrow D in FIG. 52, thereby engaging the locking element with the secondary gear.

In another embodiment, both the motor 310 and the actuator 320 may be electrically coupled to a common power source, such as a single battery pack or regulated DC power supply, such that the same source provides operating power to both components. In this configuration, the power source may be connected to a control circuit or electronic module configured to distribute electrical power to the motor 310 and the magnetic coil 328 of the actuator 320, either simultaneously or selectively, depending on operational requirements. For instance, the control circuit may supply power to the motor 310 during positioning of the system, and subsequently supply power to the actuator 320 to actuate the plunger 326 and engage the locking element 305 once the desired angular position is reached, thereby enabling coordinated operation of both components using a single shared power source.

In alternative embodiments, movement of the switchable locking element 305 and/or associated components of the system may be effected by actuators other than the solenoid actuator described above. By way of example, in one alternative configuration, the actuator 320 may comprise an electromechanical linear actuator. Such an actuator may include an electric motor operatively coupled to a lead screw, ball screw, or other linear drive mechanism configured to convert rotational motion of the motor into controlled linear displacement. Upon application of electrical power from an external or onboard power source (e.g., a battery or vehicle electrical system), the motor drives the linear mechanism to selectively extend or retract an actuator shaft, thereby translating the switchable locking element 305 in the directions indicated by arrows C and D. This arrangement may provide increased positional control, higher force output, and the ability to maintain a selected position without continuous power input, depending on the actuator design.

In another alternative embodiment, the actuator 320 may comprise a rotary actuator. The rotary actuator may include an electric motor configured to produce rotational output, which may be transmitted directly or through a gear train, cam mechanism, or linkage to effect movement of the switchable locking element 305. For example, rotational motion of the actuator output shaft may be converted into linear displacement via a cam profile, eccentric linkage, rack-and-pinion arrangement, or similar motion-conversion structure. Electrical power supplied to the rotary actuator (e.g., from a battery or external power supply) causes controlled angular displacement, which in turn drives the locking element 305 between locked and unlocked positions. Such rotary actuator configurations may be advantageous in compact assemblies or where rotational input is more readily accommodated within the system architecture.

In still further embodiments, the actuator 320 may comprise a manual actuator. The manual actuator may include, for example, a user-operable lever, button, slider, knob, or pull mechanism mechanically coupled to the switchable locking element 305. Actuation by a user imparts force directly or through intermediate mechanical linkages (e.g., cables, rods, cams, or gear mechanisms) to move the locking element 305 between operative positions. In such embodiments, no electrical power source is required, and the system may rely solely on manual input and, optionally, biasing elements such as springs to return the locking element to a default position. Manual actuator configurations may be particularly suitable for low-cost implementations, fail-safe operation, or applications where electrical power is unavailable or undesirable.

It will be appreciated that any of the foregoing actuator types may be selectively incorporated into the system, and that the specific configuration, mounting arrangement, and motion-transmission components may be varied without departing from the scope of the present disclosure, so long as the actuator is operable to effect the requisite linear movement of the locking element 305 (and any associated components coupled thereto) in the directions indicated to transition the system between its respective operative states.

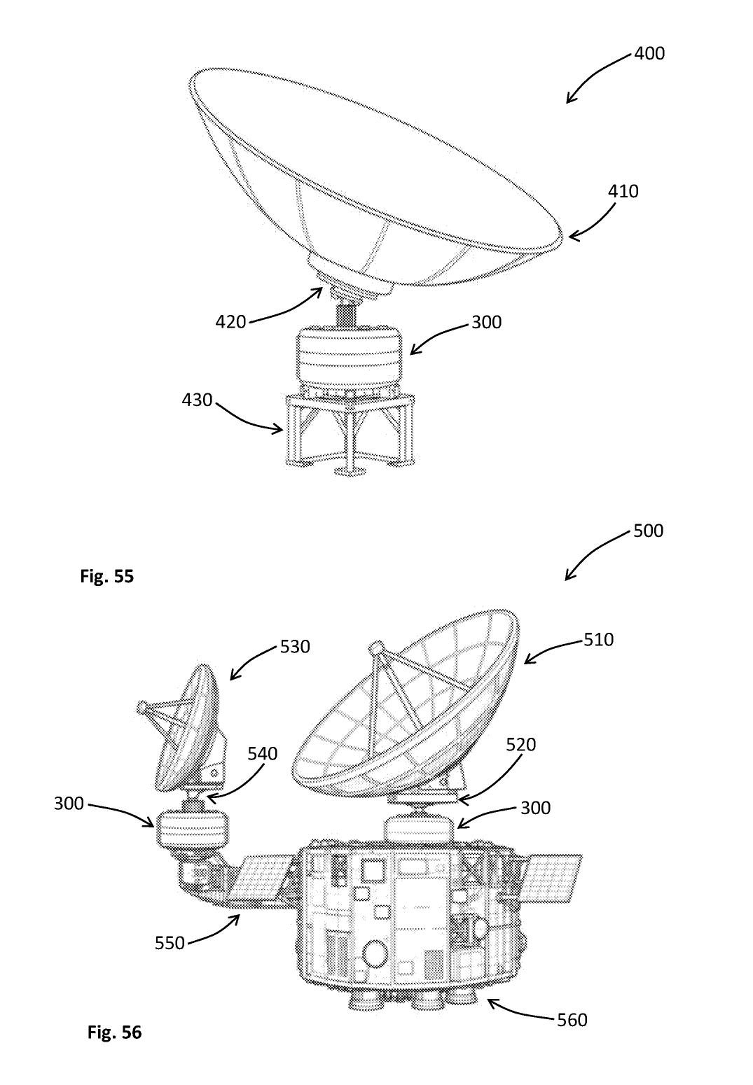

The positioning and locking system described herein may be employed in a wide range of applications requiring precise angular positioning, controlled motion, and secure load holding under static or dynamic conditions. For example, FIG. 55 illustrates a configuration, generally designated as 400, in which a single positioning and locking system 300 is used to support and position an output device 410, such as a satellite dish, antenna, sensor assembly, optical device, or similar structure requiring accurate angular orientation. The output device 410 is mounted to the system 300 via a mounting assembly 420, which may include brackets, adapters, or other structural interfaces configured to transmit loads and maintain alignment. The system 300 is in turn supported on a stand or base 430, which may be fixed or adjustable, thereby enabling controlled angular positioning of the output device 410 relative to a stationary reference frame or support structure. In this configuration, the system 300 provides both precise positioning through motor-driven rotation and secure locking through the SLD, allowing the output device 410 to be maintained at a desired angular orientation without continuous power input.

In another example, illustrated in FIG. 56, a multi-system configuration, generally designated as 500, includes a first positioning and locking system 300 supporting a first output device 510 via a mounting assembly 520, and a second positioning and locking system 300 supporting a second output device 530 via a mounting assembly 540. The second positioning system is coupled to the first system and/or to an electronic module 560 by an extension arm or structural/electronic assembly 550, which may provide both mechanical support and electrical interconnection. This arrangement enables coordinated or independent positioning of multiple output devices, allowing for complex multi-axis positioning, tracking, or alignment functions. The electronic module 560 may include control electronics, power supply components, communication interfaces, and/or processing circuitry configured to control operation of one or both positioning systems, including actuation of the motors 310 and actuators 320, and synchronization of movement between the systems.

These example implementations demonstrate that the positioning and locking system may be utilized in applications such as satellite positioning, antenna alignment, robotic or articulated arm systems, optical alignment systems, sensor positioning platforms, and other devices requiring precise, stable, and repeatable angular positioning with reliable load holding capability. It will be understood that, in the configurations described above, the system 300 may alternatively be replaced with the system 350 described above, or with any combination of positioning and locking systems having different numbers and arrangements of switchable locking devices (SLDs) and secondary gears 306. In this manner, the overall system architecture may be tailored to achieve desired performance characteristics, including angular resolution, load capacity, redundancy, and system complexity, depending on the specific application requirements.

A method of using the positioning and locking system 300 includes positioning and selectively locking an output device coupled to the drive shaft 309. In one implementation, the method comprises placing the system 300 in an unlocked state by actuating the actuator 320 such that the locking element 305 is disengaged from the corresponding secondary gear 306, thereby permitting free rotation of the gear assembly. Electrical power is then supplied to the motor 310 to rotate the drive shaft 309, which in turn drives the interior ring gear 308 and the plurality of secondary gears 306 meshing therewith, thereby causing rotation of the exterior ring gear 307 and any output device coupled thereto. As the system rotates, each secondary gear 306 sequentially reaches alignment with a corresponding angular locking position based on its phase-offset arrangement. When a desired angular position is reached, the actuator 320 is activated to move the locking element 305 axially into engagement with the pinion portion 306a of the aligned secondary gear 306, thereby preventing rotation of the engaged secondary gear and immobilizing the gear assembly to lock the system 300 in the selected angular orientation.

In another implementation, the method includes operating the system 300 in a manual mode, for example in the absence of electrical power. In this mode, the locking element 305 is first maintained or moved to the disengaged position to permit rotation of the gear assembly. The drive shaft 309 is then manually rotated, for example by applying a tool or manual force through access provided by slot 324c to the push actuator 322 or directly to the shaft 309, thereby positioning the output device at a desired angular orientation. Once the desired position is achieved, the locking element 305 is moved into engagement with the corresponding secondary gear 306, for example by manually actuating the push actuator 322a, thereby locking the system in place. In both motor-driven and manual modes, the method enables selective engagement of a single locking element 305 with a corresponding secondary gear 306 to achieve precise angular positioning and secure mechanical locking without requiring continuous power input.

In a further implementation, the method includes using the system 350 (FIG. 44), which includes a single secondary gear 306 and a single switchable locking device (SLD). In this embodiment, the method comprises placing the system 350 in an unlocked state by disengaging the locking element 305 from the secondary gear 306, and rotating the drive shaft 309, either by energizing the motor 310 or by manual actuation, to position the output device at a desired angular orientation. Because only a single secondary gear 306 is present, the available locking positions correspond to the angular alignment positions of that single gear. Once the desired angular position is reached, the actuator 320 is activated, or the push actuator 322a is manually actuated, to move the locking element 305 into engagement with the pinion portion 306a of the secondary gear 306, thereby preventing rotation of the gear assembly and locking the system in place. This method provides a simplified positioning and locking operation with reduced component complexity while maintaining secure mechanical locking and zero-power holding capability.

The positioning and locking systems 300 and 350 may be arranged and operated in a variety of orientations depending on the intended application, and are not limited to the specific orientations illustrated in the drawings. For example, in the embodiments shown in FIGS. 40-56, the system is depicted with the pinion portion 306a of the secondary gear 306 extending generally along a vertical direction relative to the housing; however, it will be understood that the system may alternatively be configured such that the pinion portion 306a extends horizontally, or at any selected angle relative to a reference frame. Similarly, the central drive shaft 309, tubular case 303, and locking element 305 may be oriented along vertical, horizontal, or inclined axes as required by the application. In use, the system 300, 350 may be mounted on horizontal surfaces, vertical supports, inclined structures, or mobile platforms, and may be oriented to provide rotational positioning about any desired axis. Accordingly, the orientations illustrated in the drawings and described in the specification are provided for purposes of illustration and explanation only, and the system may be employed in any orientation suitable for achieving the desired positioning and locking functionality without departing from the scope of the present invention.

The various components of the system according to the embodiments of the present invention may be formed from materials selected based on the functional requirements of strength, durability, weight, wear resistance, and environmental conditions of use. By way of example, structural components such as the top cover 302, bottom cover 312, exterior ring gear 307, and mounting plate 315 may be formed from metals including aluminum alloys, stainless steel, or other high-strength engineering metals, or alternatively from high-performance polymers or composite materials to reduce weight while maintaining structural integrity. The gears, including the interior ring gear 308 and secondary gears 306, may be formed from hardened steel, alloy steel, or other wear-resistant materials, and may optionally be surface-treated, such as through carburizing, nitriding, or coating, to enhance durability and reduce friction. The locking element 305 may likewise be formed from hardened or tool steel, or other high-strength materials capable of withstanding repeated engagement loads without deformation. Components such as the tubular case 303 and bushing 304 may be formed from low-friction, wear-resistant materials, including bronze, polymer composites, or engineered plastics, to facilitate smooth movement and alignment. The shaft 309 and support shafts 311 may be formed from high-strength metals to withstand torsional and radial loads. The actuator components, including the core 324, plunger 326, and magnetic coil 328, may be formed from materials suitable for electromagnetic operation, such as ferromagnetic metals for the core and plunger, and conductive wire (e.g., copper) for the coil. It will be understood that the specific materials may be varied depending on the intended application, including corrosion-resistant materials for outdoor or marine environments, lightweight materials for aerospace applications, or reinforced materials for high-load industrial uses, without departing from the scope of the present invention.

The positioning and locking system described herein provides significant advantages over conventional positioning mechanisms by combining precise angular control with robust mechanical locking in a compact and modular architecture. In particular, the use of the switchable locking device (SLD), including the locking element 305 selectively engageable with the secondary gear 306, enables the system to achieve secure, positive locking through direct mechanical engagement rather than friction-based resistance. This allows the system 300/350 to maintain a selected angular position without continuous power input, thereby improving energy efficiency and reducing wear on drive components such as the motor 310. Additionally, the phase-offset arrangement of multiple secondary gears 306 enables the system to achieve high-resolution angular positioning through selective engagement of a single gear at a time, eliminating the need for complex multi-stage gear trains while maintaining precise and repeatable positioning capability.

Further advantages are realized through the distributed load path and structural configuration of the system. The interaction between the interior ring gear 308, exterior ring gear 307, and multiple secondary gears 306 allows applied loads to be shared across multiple components, thereby reducing localized stress concentrations and enhancing durability and reliability. The integration of both motor-driven and manual modes of operation provides additional flexibility, allowing the system to function under powered conditions as well as in fail-safe scenarios where power is unavailable. Moreover, the modular nature of the system permits customization of performance characteristics, including angular resolution, load capacity, and redundancy, through variation in the number and arrangement of secondary gears 306 and associated SLDs and actuators. As a result, the system is well-suited for a wide range of applications requiring precise, stable, and energy-efficient positioning with reliable locking capability.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but are to be accorded the widest scope consistent with the principles and novel features disclosed herein.

1. A switchable locking device comprising:
a tubular case defining an internal space; and
a locking element configured to be received entirely within the internal space of the tubular case and to slide along a central axis of the tubular case;
wherein the locking element is configured to slide in a first direction along the central axis to connect the tubular case to a rotatable transmission member and in a second direction opposite to the first direction to disconnect the tubular case from the rotatable transmission member, the locking element remaining entirely within the internal space of the tubular case during sliding movement in the first and second directions.

2. The switchable locking device according to claim 1, wherein: the locking element comprises a plurality of external locking teeth and a plurality of internal locking teeth; the tubular case comprises a plurality of internal slots configured to receive and lockingly engage the respective external locking teeth of the locking element, whereby the locking element is permitted to slide along the central axis of the tubular case; and the internal locking teeth of the locking element are configured to engage external teeth of the rotatable transmission member when the locking element moves in the first direction, thereby connecting the tubular case to the rotatable transmission member.

3. The switchable locking device according to claim 2, wherein the locking element is configured to slide along the rotational transmission member in the first and second directions by engagement of the internal locking teeth of the tubular locking element with the external teeth of the rotatable transmission member.

4. The switchable locking device according to claim 2, wherein the rotatable transmission member is prevented from undergoing rotation when the tubular case is connected to the transmission member.

5. A positioning and locking system having at least one switchable locking device according to claim 1.

6. The positioning locking system according to claim 5, wherein the at least one switchable locking device comprises a plurality of switchable locking devices.

7. A positioning and locking system for positioning and locking an output member, the system comprising:
a transmission assembly configured to transmit rotational motion;
a locking device including a locking element movable between an unlocked position and a locked position; and
an actuator operatively coupled to the locking element and configured to move the locking element between the unlocked position and the locked position;
wherein, in the unlocked position, the transmission assembly is permitted to rotate to position the output member; and
wherein, in the locked position, the locking element engages a portion of the transmission assembly to prevent rotation of the transmission assembly and thereby maintain the output member in a locked position.

8. The positioning and locking system according to claim 7, wherein the transmission assembly includes a drive shaft and at least one rotatable transmission member operatively coupled to the drive shaft.

9. The positioning and locking system according to claim 8, wherein the rotatable transmission member comprises a compound gear having a first toothed portion and a second toothed portion.

10. The positioning and locking system according to claim 9, wherein the locking element is configured to selectively engage the first toothed portion of the compound gear to prevent rotation of the transmission assembly.

11. The positioning and locking system according to claim 1, further comprising a tubular case configured to receive the locking element and guide axial movement of the locking element between the unlocked position and the locked position.

12. The positioning and locking system according to claim 1, wherein the actuator comprises a solenoid actuator including a plunger operatively connected to the locking element to move the locking element between the unlocked position and the locked position.

13. The positioning and locking system according to claim 7, wherein the transmission assembly comprises a drive shaft configured to rotate about an axis, an interior ring member operatively coupled to the drive shaft, an exterior ring member, and at least one rotatable transmission member disposed between the interior ring member and the exterior ring member, the rotatable transmission member being configured to transmit rotational motion between the interior ring member and the exterior ring member.

14. The positioning and locking system according to claim 13, wherein, in the locked position of the locking element, the locking element engages a toothed portion of the rotatable transmission member to prevent rotation of the rotatable transmission member relative to the interior ring member and the exterior ring member.

15. A positioning and locking system comprising:
a transmission assembly configured to transmit rotational motion and including at least one rotatable transmission member;
at least one switchable locking device comprising:
a tubular case defining an internal space; and
a locking element configured to be received entirely within the internal space of the tubular case and to slide along a central axis of the tubular case;
wherein the locking element is configured to slide in a first direction along the central axis to connect the tubular case to the rotatable transmission member and in a second direction opposite to the first direction to disconnect the tubular case from the rotatable transmission member, the locking element remaining entirely within the internal space of the tubular case during sliding movement in the first and second directions; and
an actuator operatively coupled to the locking element and configured to move the locking element between the first and second directions;
wherein, when the locking element connects the tubular case to the rotatable transmission member, rotation of the transmission assembly is prevented, and when the locking element disconnects the tubular case from the rotatable transmission member, rotation of the transmission assembly is permitted.

16. The positioning and locking system according to claim 15, wherein the transmission assembly further comprises a drive shaft, an interior ring member operatively coupled to the drive shaft, and an exterior ring member, and wherein the at least one rotatable transmission member is disposed between the interior ring member and the exterior ring member and is configured to transmit rotational motion therebetween.

17. The positioning and locking system according to claim 15, wherein the rotatable transmission member comprises a compound gear including a first toothed portion and a second toothed portion, the first toothed portion being configured to engage the locking element and the second toothed portion being configured to mesh with at least one of the interior ring member or the exterior ring member.

18. The positioning and locking system of claim 15, wherein the locking element includes locking teeth configured to selectively engage corresponding teeth of the rotatable transmission member when the locking element is moved in the first direction.

19. The positioning and locking system according to claim 15, wherein: the at least one rotatable transmission member comprises a plurality of rotatable transmission members; the at least one switchable locking device comprises a plurality of switchable locking devices, each switchable locking device including a respective tubular case and a respective locking element associated with a corresponding one of the plurality of rotatable transmission members; and the actuator comprises a plurality of actuators, each actuator being operatively coupled to a respective locking element and configured to independently move each locking element along a central axis of the corresponding tubular case to selectively connect the tubular case to or disconnect the tubular case from the corresponding rotatable transmission member.

20. The positioning and locking system according to claim 19, wherein each locking element includes first locking teeth configured to engage corresponding teeth of the rotatable transmission member and second locking teeth configured to engage respective slots of the tubular case to prevent rotation of the locking element relative to the tubular case while permitting axial movement of the locking element within the tubular case.
